(19) United States
(12) Patent Application Publication
(10) Pub. No.: US 2022/0124062 A1
(43) Pub. Date: Apr. 21, 2022

(54) GEOGRAPHICALLY TAILORED COMMUNICATION SOLUTION PLATFORMS

(71) Applicant: UBIR Technology, Inc., Auburn, AL (US)

(72) Inventors: John Lapeyrouse, Auburn, AL (US); William Lapeyrouse, Spanish Fort, AL (US)

(21) Appl. No.: 17/501,828

(22) Filed: Oct. 14, 2021

Related U.S. Application Data
(60) Provisional application No. 63/092,466, filed on Oct. 15, 2020.

(51) Int. Cl. H04L 12/58; H04W 4/14; H04L 29/08

(52) U.S. Cl. CPC H04L 51/20; H04L 67/20; H04L 51/046; H04W 4/14

(57) ABSTRACT

Methods, systems and computer program products for implementing an omnichannel platform adapted to facilitate geographically specific communications by opening channels of communication between front end devices and service response systems, all without need of directing the messages at a phone number or email address.

### CROSS REFERENCE

This application claims priority to U.S. Provisional Application No. 63/092,466 filed on Oct. 15, 2020, the entirety of which is hereby incorporated by reference.

### BACKGROUND

Localized and geographically tailored messaging systems may be useful for avoiding face-to-face communication, increasing efficiency, gathering data on message traffic, and allowing address free communications, but current solutions are not tailored for individualized communications for local networks. Instead, broad and Internet wide based communications are the only offerings, and such generic systems are not tailored or customized for individual, geographically isolated situations.

Consequently, there is a significant need in the industry for improved electronic communication platforms with comprehensive omnichannel features, better data analytics, lower adoption costs, which can be deployed in geographically tailored environments.

Back end service providers have been under competitive pressure to improve their engagements with users, the ordering process from users, and the ways in which the service response system operators service their users. Further such back end service providers also desire to acquire better data about their users, including user purchasing and behavioral data, and to enhance the ways in which the merchants use such data to improve their business models and operations. Also, in the event of public health emergencies or pandemics caused by pathogens that may be transmitted through air or through contact with objects, authorities may mandate enhanced sanitation procedures and/or increased social separation between users, and between users and merchant staff. Current technologies adopted by various such merchants may not meet their business and operational needs adequately, and/or opportunities may exist for further improvement of solutions currently available commercially for such back end service providers and users.

### SUMMARY

In examples, systems and methods here include by a server computer in communication with a network, configured to send and receive messages within a geographical location, receiving a request from a front end device, assigning a geo-code to the requesting front end device, wherein, the geo-code includes a geographical subunit configured to identify a geographical location of the front end device and a message subunit configured with predetermined messages that correlate to the geographical location of the front end device, by the server computer, receiving a log-in identifier from the front end device through the log-in portal, by the server computer, authenticating the front end device, by the server computer, receiving a selected message of the message subunits from the authenticated front end device, the selected message allows communicating with a service response system correlated to the message subunit, And routing the received selected message to the service response system correlated with the message subunit by a server computer in communication with a network, configured to send and receive messages within a geographical location, receiving a request from a front end device, the request including data regarding a geo-code, wherein, the received geo-code correlates to a geographical subunit, the geo-code is part of a URL of a log-in portal, by the server computer, receiving a log-in identifier from the front end device through the log-in portal, by the server computer, authenticating the front end device, by the server computer, sending the authenticated front end device a main communications page that allows communicating with a service response system, the service response system in communication with the server computer, receiving a selection, by the main communication page, from previously determined communications shortcuts or free text communications shortcuts, configured to be filtered and sent to the service response system, and sending the received selection of previously determined communications shortcut to the service response system using the filters and without requiring an address to send and receive messages to the service response system users. Some examples, further comprising, receiving, at the service response system devices, only messages from the front end device that have been previously filtered to relate to the service response system. Additionally or alternatively, in some examples, further comprising, allowing the users of the service response system to respond to the filtered messages using pre-selected responses, or free text entry. Additionally or alternatively, in some examples, further comprising, display of a count-up message timer on the main communications page when one of the communication shortcuts is selected by a user of the front end device, and display of a synchronized count-up message timer on the service response system subunit for the same message. Additionally or alternatively, in some examples, further comprising, allowing the users of the service response system to stop and remove the user interface icon of a count-up message timer.

Additionally or alternatively, in some examples, further comprising, storing data regarding the count-up timers and elapsed time when the service response system users turn off the count-up timers, as well as geographical subunits correlated to each of the count-up timers and analyzing the data to determine trends.

Additionally or alternatively, in some examples, further comprising, allowing the users of the service response system to order the messages from the front end device by selecting the corresponding geographical subunits to which the received geo-codes are sent. Additionally or alternatively, in some examples, further comprising, allowing the users of the service response system to order the messages from the front end device by selecting the corresponding timers corresponding to the count-up timer of when the messages were sent. Additionally or alternatively, in some examples, wherein the main communications page for the front end user includes a pass-through button, the pass through button linking a third party website or external application to the main communications page, and redirecting the device to the third party website or opening of the external application if selected on the main communications page.

Additionally or alternatively, in some examples, wherein the main communications page is configured to allow messages between the front end device and service response system, using at least one of text, voice recording, video, and image capture. Additionally or alternatively, in some examples, wherein the geo-code is at least one of, a URL with parameters containing the geo-code information, a quick reference (QR) code which contains this URL, a moving image validation, or a barcode containing the geo-code information.

Additionally or alternatively, in some examples, further comprising, causing storage of every front end device identifier and correlating a session that the front end device is utilizing the local wireless network. Additionally or alternatively, in some examples, further comprising, causing storage of data regarding at least one of, every message sent and received by every logged in front end device, timing of every message sent, as well as the corresponding geographic subunit for analysis of trends.

Additionally or alternatively, in some examples, further comprising, determining, by the server computer, at least one analytical report using a subset of data from at least one of the stored message, log-in, and timing data. Additionally or alternatively, in some examples, wherein the data used to determine the analytical report is at least one of, a service metric, performance data of staff, a number of service requests, a time interval between requests, an efficiency metric for a plurality of requests, and a problem with a request.

Additionally or alternatively, in some examples, further comprising, by the server computer, receiving a selection, by the main communication page, of a free-text message correlated to one of the communications shortcuts, allowing free-text entry by the user of the front end device, and sending the received free-text entry to the filtered back end subunit without requiring an address to send and receive messages to the service response system users.

Additionally or alternatively, in some examples, wherein authenticating the front end device includes, by the server computer, after receiving the log-in identifier, sending a code by short message system (SMS) to the front end device, by the server computer, receiving a response code from the front end device, comparing the received response code and the sent code, and if the response code matches the sent SMS code, authenticating.

Additionally or alternatively, in some examples, wherein authenticating the front end device includes causing storage of the received log-in identifier and an indicator that the received log-in identifier is authenticated.

Additionally or alternatively, in some examples, a method of communicating, comprising, receiving, at a service response system device, a message from a front end device, by a back end network, wherein the service response system subunit device and the front end device are in communication with a network, wherein the message from the front end device having been selected from a previously arranged communication shortcut and filtered to apply to the service response system device configuration from multiple service response system devices, each configured to display messages intended for a subunit, causing display, at the filtered service response system subunit device, the message received from the front end device, along with a geographical subunit correlated to the physical location of the front end device as determined by the authenticated geo-coded communication channel for the front end device, allowing a user of the service response system subunit device to order messages received from multiple other front end devices, each with their own geo-code correlated physical location, allowing the user of the service response system subunit device to send response messages to the front end device in response to a received message. Additionally or alternatively, in some examples, further comprising, by the back end network, causing storage of time data for messages sent between front end devices and service response system subunits.

Additionally or alternatively, in some examples, further comprising, by the back end network, causing storage of message traffic data for messages sent between front end devices and service response system subunits. Additionally or alternatively, in some examples, further comprising, by the back end network, causing storage of geographic location of front end devices that send messages to the service response system subunits. Additionally or alternatively, in some examples, further comprising, by the back end network, performing analytics on the timing, message, and geographical location data by determining frequency rates of messages at specific times in specific geographical locations.

Additionally or alternatively, in some examples, non-transitory computer-readable medium having computer-executable instructions thereon for a method of communication, the method comprising: receiving a request to authenticate from a front end device, the request including a geo-code, sending, by a retrieval component, an authentication page, receiving, by an authentication component, an authentication response and authenticating the front end device using the authentication response, sending a main communications page to the front end device, receiving selection of a pass-through link on the main communications page and directing the front end device to a third party website or external application correlated to the pass-through link, receiving a selection of pre-determined message shortcuts, or free text messages, each pre-determined message shortcut filtered to a service response system subunit such that no address is required and the message shortcuts are automatically sent to the correlated service response system subunit upon selection. Additionally or alternatively, in some examples, wherein the geo-code is a code physically affixed to a geographical subunit of a geographical location. Additionally or alternatively, in some examples, wherein geo-code is a quick reference (QR) Code. Additionally or alternatively, in some examples, wherein the wherein the device is one of a mobile smartphone, a tablet, a laptop, and a wearable device.

Additionally or alternatively, in some examples, a method comprising: by an application running on a front end device, sending a message from a front end device the message including data regarding a geo-code, wherein, the sent geo-code correlates to a geographical subunit, the geo-code is part of a URL of a log-in portal, by the application, sending a login identifier by the log-in portal to a back-end server computer for authentication, receiving, from the back-end server computer, a main communications page that allows communicating with a service response system, the service response system in communication with the back-end server computer, and sending a selection, by the main communication page, from previously determined communications shortcuts or free text communications shortcuts, each filtered for the service response system, such that the user of the front end device does not need to enter an address to send and receive messages to service response system users.

Additionally or alternatively, in some examples, wherein authenticating the front end device includes, by the server computer, after receiving the log-in identifier, sending a code by short message system (SMS) to the front end device, by the server computer, receiving a response code from the front end device, comparing the received response code and the sent code, and if the response code matches the sent SMS code, authenticating.

Additionally or alternatively, in some examples, wherein authenticating the front end device includes causing storage of the received log-in identifier and an indicator that the received log-in identifier is authenticated.

Additionally or alternatively, in some examples, further comprising, by the server computer, causing display of a count-up message timer on the main communications page when one of the communication shortcuts is selected by a user of the front end device.

Additionally or alternatively, in some examples, a method comprising: by a server computer in communication with a network, configured to send and receive messages to restaurant customer devices within a restaurant, receiving a message from a restaurant customer device the message including data regarding a geo-code, wherein, the received geo-code correlates to a table within the restaurant, the geo-code is part of a URL of a log-in portal, by the server computer, receiving a log-in identifier from the restaurant customer device from the log-in portal, by the server computer, authenticating the restaurant customer device, by the server computer, sending the authenticated restaurant customer device a main communications page that allows communicating with a restaurant system, the restaurant system in communication with the server computer, receiving a selection, by the main communication page, from service option communications shortcuts or free text communications shortcuts, each filtered for a restaurant system subunit, of the restaurant system, such that the user of the restaurant customer device does not need to enter an address to send and receive messages to restaurant system users, and sending the received selection of previously determined service option communications shortcuts to the filtered restaurant system without requiring an address to send and receive messages to the restaurant system users.

Additionally or alternatively, in some examples, wherein the restaurant system subunits include at least one of a wait staff, kitchen staff, and custodian staff

Additionally or alternatively, in some examples, a method of communicating, comprising, receiving, at a restaurant system device, a message from a restaurant customer device, by a back end network, wherein the restaurant system subunit device and the restaurant customer device are in communication with a network, wherein the message from the restaurant customer device having been selected from a previously arranged communication shortcut filtered for the restaurant system subunit device, causing display, at the restaurant system device, the message received from the restaurant customer device that is filtered, along with a table correlated to the restaurant of the restaurant customer device geo-code identifier, allowing a user of the restaurant system subunit device to order messages received from multiple other restaurant customer devices, each with their own geo-code correlated table, allowing the user of the restaurant system subunit device to send response messages to the restaurant customer device in response to a received message.

Additionally or alternatively, in some examples, wherein the restaurant system subunit is at least one of a wait staff, kitchen staff, and custodian staff.

Additionally or alternatively, in some examples, a method comprising: by a server computer in communication with a network, configured to send and receive messages to venue customer devices within a venue, receiving a message from a venue customer device the message including data regarding a geo-code, wherein, the received geo-code correlates to a seat within the venue, the geo-code is part of a URL of a log-in portal, by the server computer, receiving a log-in identifier from the venue customer device from the log-in portal, by the server computer, authenticating the venue customer device, by the server computer, sending the authenticated venue customer device a main communications page that allows communicating with a security system, the security system in communication with the server computer, receiving a selection, by the main communication page, from security option communications shortcuts or free text communications shortcuts, each filtered for the security system, such that the user of the venue customer device does not need to enter an address to send and receive messages to security system users, and sending the received selection of previously determined security option communications shortcuts to the filtered security system without requiring an address to send and receive messages to the security system users.

Additionally or alternatively, in some examples, wherein the security system include at least one of a medical and physical security.

Additionally or alternatively, in some examples, a method of communicating, comprising, receiving, at a security system subunit device, a message from a venue customer device, by a back end network, wherein the security system subunit device and the venue customer device are in communication with a network, wherein the message from the venue customer device having been selected from a previously arranged communication shortcut filtered for the security system device from multiple security system devices. causing display, at the correlated security system device, the message received from the venue customer device that is filtered, along with a seat correlated to the venue of the venue customer device geo-code identifier, allowing a user of the security system subunit device to order messages received from multiple other venue customer devices, each with their own geo-code correlated seat, allowing the user of the security system subunit device to send response messages to the venue customer device in response to a received message. Additionally or alternatively, in some examples, wherein the security system is at least one of a medical and physical security staff

Additionally or alternatively, in some examples, a method comprising: by a server computer in communication with a network, configured to send and receive messages to hospital patient devices within a hospital, receiving a message from a hospital patient device the message including data regarding a geo-code, wherein, the received geo-code correlates to a room within the hospital, the geo-code is part of a URL of a log-in portal, by the server computer, receiving a log-in identifier from the hospital patient device from the log-in portal, by the server computer, authenticating the hospital patient device, by the server computer, sending the authenticated hospital patient device a main communications page that allows communicating with a medical system, the medical system in communication with the server computer, receiving a selection, by the main communication page, from medical option communications shortcuts or free text communications shortcuts, each filtered for the medical system, such that the user of the hospital patient device does not need to enter an address to send and receive messages to medical system users, and sending the received selection of previously determined medical option communications shortcuts to the filtered medical system without requiring an address to send and receive messages to the medical system users. Additionally or alternatively, in some examples, wherein the medical system include at least one of a nurse, doctor, pharmacy, physical security, and hospitality staff

Additionally or alternatively, in some examples, method of communicating, comprising, receiving, at a medical system subunit device, a message from a hospital patient device, by a back end network, wherein the medical system device and the hospital patient device are in communication with a network wherein the message from the hospital patient device having been selected from a previously arranged communication shortcut filtered for the medical system subunit device from multiple medical system devices. causing display, at the medical system device, the message received from the hospital patient device that was filtered, along with a room correlated to the hospital of the venue customer device geo-code identifier, allowing a user of the medical system subunit device to order messages received from multiple other hospital patient devices, each with their own geo-code correlated room, allowing the user of the medical system subunit device to send response messages to the hospital patient device in response to a received message. Additionally or alternatively, in some examples, wherein the medical system include at least one of a nurse, doctor, pharmacy, physical security, and hospitality staff.

Additionally or alternatively, in some examples, a method comprising: by a server computer in communication with a network, configured to send and receive messages to venue customer device within a venue, receiving a message from a venue customer device the message including data regarding a geo-code, wherein, the received geo-code correlates to a seat within the venue, the geo-code is part of a URL of a log-in portal, by the server computer, receiving a log-in identifier from the venue customer device from the log-in portal, by the server computer, authenticating the venue customer device, by the server computer, sending the authenticated venue customer device a main communications page that allows communicating with a security system, the security system in communication with the server computer, receiving a selection, by the main communication page, from security option communications shortcuts or free text communications shortcuts, each filtered for a security system subunit of the security system, such that the user of the venue customer device does not need to enter an address to send and receive messages to security system users, and sending the received selection of previously determined security option communications shortcuts to the security system without requiring an address to send and receive messages to the security system users, and determining, by the server computer, at least one analytical report using data from the geo-code and log-in identifier regarding location and time of venue customer device to track pathogen contact among multiple front end users and security system users.

Additionally or alternatively, in some examples, a method of communicating, comprising, receiving, at a medical system subunit device, a message from a hospital patient device, by a back end network, wherein the medical system subunit device and the hospital patient device are in communication with a network, wherein the message from the hospital patient device having been selected from a previously arranged communication shortcut filtered for the medical system device from multiple medical system devices. causing display, at the medical system device, the message received from the hospital patient device that was filtered, along with a room correlated to the hospital of the venue customer device geo-code identifier, allowing the user of the medical system subunit device to send response messages to the hospital patient device in response to a received message, and determining, by the server computer, at least one analytical report using data from the geo-code regarding location and time of venue customer device to track pathogen contact among multiple hospital patients and medical system subunit users.

### INCORPORATION BY REFERENCE

All publications, patents, and patent applications mentioned herein, if any, are incorporated by reference to the same extent as if each such individual publication, patent, or patent application were specifically and individually indicated to be incorporated by reference. To the extent that any inconsistency or conflict may exist between information expressly disclosed herein and information disclosed in any publications, patents, or patent applications that are incorporated by reference in this patent, the information expressly disclosed in this patent application (or patent, upon issuance) will take precedence and prevail.

### BRIEF DESCRIPTION OF THE DRAWINGS

The accompanying figures, which together with the detailed description below are incorporated in and form part of the specification, serve to further illustrate various embodiments and to explain various principles and advantages all in accordance with example embodiments of the present inventions.

FIG. 1 shows an example network diagram and communication pages in accordance with embodiments described herein;

FIG. 2 shows an example authentication network example, in accordance with embodiments described herein;

FIG. 3 shows an example Solution Users and Providers , in accordance with embodiments described herein;

FIG. 4 shows an example map arrangement in accordance with embodiments described herein;

FIG. 5 shows another map arrangement in accordance with embodiments described herein;

FIG. 6 shows a geographic order management process adapted to facilitate transactions between a geographic location and a user, in accordance with embodiments described herein;

FIG. 7 shows example front end communication pages in accordance with embodiments described herein;

FIG. 8 shows another example front end communication pages in accordance with embodiments described herein;

FIG. 9 shows another example front end communication pages in accordance with embodiments described herein;

FIG. 10 shows an example back end communication pages in accordance with embodiments described herein;

FIG. 11 shows another example back end communication pages in accordance with embodiments described herein;

FIG. 12 shows another example back end communication pages in accordance with embodiments described herein;

FIG. 13 shows another example back end communication pages in accordance with embodiments described herein;

FIG. 14 shows another example back end and front end communication pages in accordance with embodiments described herein;

FIG. 15 shows a user ordering process adapted to facilitate transactions between a user and a geographic location, in accordance with embodiments described herein;

FIG. 16 shows an exemplary architecture of a platform in accordance with embodiments described herein; and

FIG. 17 shows an exemplary architecture of a data processing device in accordance with embodiments described herein.

FIG. 18 shows a representation of an exemplary data processing system that may be used in connection with various embodiments and that may be configured to execute instructions for performing functions and methods described and/or claimed in connection with embodiments described herein.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the invention to these particular embodiments. In other instances, well-known data structures, timing protocols, software operations, procedures, and components have not been described in detail so as not to unnecessarily obscure aspects of the embodiments of the invention.

Overview

The systems and methods described herein may be used for establishment and use of a communications system that is tailored for a specific geographic solution. By using systems and methods to direct network traffic to a geographically specified location, software applications running on mobile wireless computer devices, and service response systems in communication with the network, a specialized custom solution may be delivered for front end users to interact with and coordinate with service response system users based on the specific geographic location and established infrastructure allowing for address free yet efficiently directed communications.

In some examples, a diner user utilizing the communication system in a brick-and-mortar restaurant may be used in this disclosure, a hospital and/or warehouse example. Such examples are not intended to be limiting. Many various use cases may be programmed into the system in order to allow for specific geographically salient solutions to be utilized, including, but not limited to security communications, health and medical communications, fire and police communications, education communications, or any various other use cases. By selecting the examples of a restaurant for this disclosure, a warehouse and/or hospital, the Applicants in no way restrict the innovations and solutions to such a use case, nor does it narrow the scope of the communications solutions presented.

Systems and methods here allow for communication messages without first finding an address such as a phone number for a “short code”(SMS) or an email address or other specific recipient. In such examples, the system may have addresses built into the system to allow for front end devices to communicate with specific service response systems according to predetermined rules. In some examples, that may include an address shortcut such as a HOST or NURSE or SECURITY, which the system properly routes to the predetermined service response system subunit as described herein. The systems and methods allow specific users correlated in the system by their geographical location and service response systems to message by filtering the messages in a pre-loaded manner to ensure a correct recipient is notified, based on a type or category of message that is generated. Such previously created, or standard messages may be tailored for a specific geographical location and purpose, to thereby more easily route by filtering as required. In some examples, additionally or alternatively, ad hoc or free text messages may be used as well as previously determined messages, as described herein. Such an arrangement may enable a specific back end to only receive the messages relevant to that back end group for response. Such back end directed messages may be displayed to the group that is appropriate without any effort by the sending front end user or back end user, and may be accomplished automatically by the system.

Additionally or alternatively, the systems and methods here may be used to track and collect timing data on message traffic, response times, commonly used pre-selected messages, common user logins, geographic and geographic subunit data of message traffic, and any amount of other customized data gathering and analysis. Such analysis may be used to change the message system by editing the previously arranged message shortcuts, routing of message traffic to different service response systems, or any other kind of customization, based on the data received and analyzed, for a specific geographical location. In addition, if aggregate data is obtained for more than one geographical location, that data may be analyzed for trends of communications, timing responses, etc. to change the message system as well.

Additionally or alternatively, messages may be automatically prioritized by the system according to previously determined rules programmed into the system software.

It should be noted that the terms wired and wireless are not intended to be limiting. The systems and methods described herein may be used by wireless and/or wired computing devices and/or networks, in a local area network, a wide area network, Internet, cloud or distributed system, or by any future method of computing communication as described herein, alone or in combination.

Example Geographically Customized Communication Service Network

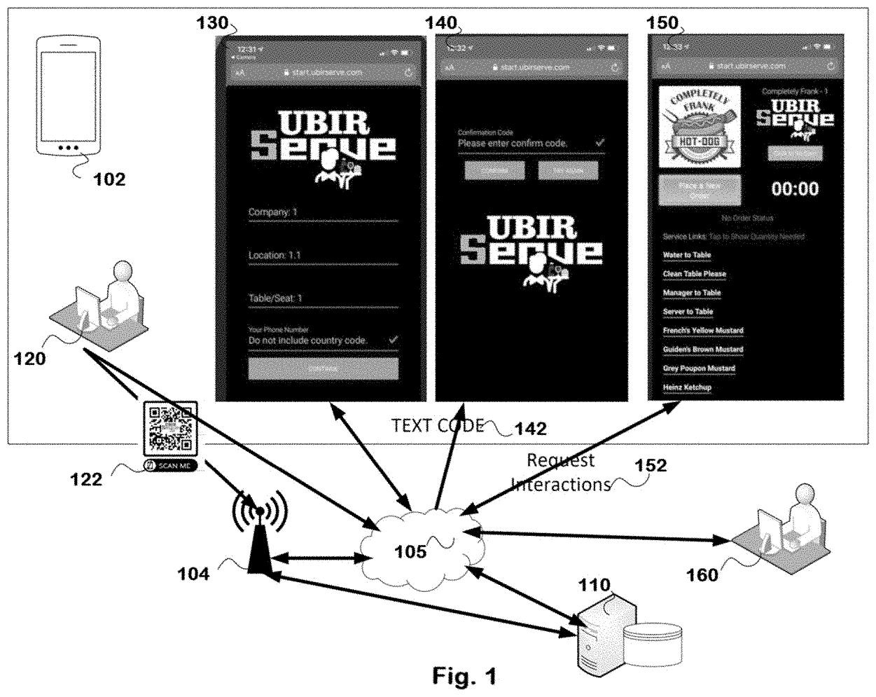

In FIG. 1, an example communication service is shown, that is customized to a specific geographic location and specific technical needs of that location. In the example, a smartphone or any other wireless system 102 is brought within range of a local network 104, and/or in communication with a cellular or other communications system such as the Internet or Wide Area Network 105. Any kind of connection could be used to communicate with a back end system 110.

In some examples, additionally or alternatively, the system may force front end device 102 traffic to originate on a local network to minimize risk of abuse, and in such examples, all traffic may be accepted over the internet via local WiFi, Cellular, etc. through the Internet 105 or any communications network available.

In some examples, that network allows for wireless connectivity 104 by any number of wireless devices or mobile devices operated by various users. In some examples, that wireless network is a WiFi network, in some examples, it may be a 5G cellular style network, in some examples it may be a Bluetooth Low Energy network, or any short to medium range wireless systems may be used to communicate, connect communication channels to the smartphone or other computing device 102 and the antennae 104 and thereby a back-end system 110. Such a back end system 110 may be a server with database capabilities or other computing system to operate the network and send and receive data to both a front end device 102 and service response system 160 as well as archive, save, or otherwise collect data regarding user devices 102, time of messages, time of login/logout, content of messages, and any other data regarding the communications systems described herein for analytics or other purposes.

As shown in the example, a user of the wireless device 102 may log into the network 104 and back end system 110, at the geographical location using the following steps and systems. Once in range of the network, the smartphone or other wireless device 102 may be used by a user to capture a geo-code such as but not limited to a barcode or quick response (“QR”) code 122 located on a physical object 120 in the location. Such a capture may be through a camera system on the individual wireless device 102 using software to capture and save the image to send to the network 110, and/or in some examples, interprets the geo-code as a URL instruction to request a login page with the specific parameters for that location passed as parameters as part of the URL address.

In some examples, alone or in combination, a link (URL) on a web page may be made available to the wireless device 102, to initiate a login sequence.

Examples of physical objects in the physical location that contain the geo-code may include but may not be limited to a desk, chair, table, wall, post, ceiling, floor, door, doorjamb, corkboard, whiteboard, chalkboard, announcement board, or other object 120. The object 120 may not be secured to or part of the physical room, such as but not limited to a paper, handout, laminated paper, menu, cup, tray, placemat, computer screen, or other object 122. Such a code image capture allows the system 110 to verify the physical location of the smart device 102 because the individual codes are unique and the location of each is known to the system 110 and/or system administrators.

In some examples, additionally or alternatively, a Global Positioning System (GPS) in the wireless device 102 may pass location information to the back end system 110 as well as the geo-code information. GPS information may further be used to authenticate location of the wireless device 102 with the geo-tag information for an optional added layer of authentication.

In some examples, additionally or alternatively, a method of validation or authentication may include validating location in allowed location by moving video image displayed live at the location in real time. Display on TV in location or jumbotron in large venue which may be more difficult to fake since it is not a static image.

In some examples, a single geographic location may include one code 122 repeated throughout the entire geographic location where the system is deployed. In some examples, a single geographic location covered by the network 104 may include a plurality of unique codes, representing geographic subsets or subunits of the overall geographic location. For example, in an arena, each seat may include a unique code, in a hospital, each room may contain a unique code, in a neighborhood or office building, each address may include a unique code, in a restaurant, each table may include a unique code. In any example where a single geographic location may be segmented into subunits, each subunit may include a unique code, and that unique code may be correlated in the system 110 to a specific map, area, directions, or other physical corresponding pointer for back end users and systems to identify and locate.

When the user is able to capture the geo-code such as a barcode and/or QR code 122, the system 110 verifies that the geo-code is located within the geographical location of the network 104, the system 110 may then direct the wireless device 102 or send the wireless device 102 to a login screen 130. Such a screen may prompt the user to input a name, location, and/or phone number, or any customized identifying information. Once submitted to the service response system 110, the service response system 110 may direct the user wireless device 102 to a confirmation code screen 140 and also send a text message, email, short message service SMS, or other communication 142 with a numerical and/or alphabetical code sequence. The user may input the received text message code 142 into the code screen 140 and the service response system 110 may use that information to authenticate the wireless device 102. By authenticating in such a manner, the user wireless device 102 has established that it is in the physical location of the QR or barcode 122 and is logged into the back end system 110 and/or local network 104. Such an example may also establish that the user of the front end device is in possession and control of their device and not someone else using their phone number.

Next, once the wireless device 102 is authenticated, a main communications page 150 may be displayed for the user. This main communications page 150 may be tailored for the specific geographical location where the barcode or QR code 122 is located and allow customized routing and directing of messages to and from the front end wireless users 102 and the service response systems 160 and/or subunits of each. In some examples, it may be a warehouse with information on product locations, desired product movement, and communications for foremen and warehouse workers to interact. In some examples, it may be a hospital allowing doctors, nurses, and staff to check on patients, administer medicine, move equipment, call for cleanings, or other medical requirements. In some examples, it may be utilized in a restaurant allowing a customer to order food and service items to a table and allow the wait staff and back end cooks to properly provide service. It may be a security or wellness response system allowing patrons to interact with and call security or medical staff. Any or more examples may be use cases for the systems and methods described here and use of one example or another is not intended to be limiting in any way.

In any arrangement, the communication may then be established between the wireless device 102 user and a service response system 160 in the designated geographical location. The messages between the wireless device 102 and service response system 160 may utilize the various pre-arranged button shortcuts, or other systems as described herein to communicate without the need for address entry, because the system automatically routes communications as described herein.

In some examples, routing of such message traffic may be accomplished by filtering the messages between front end user 102 and service response system 160 users and groups in a pre-loaded manner to ensure a correct recipient is notified, based on a type or category of message that is generated. Such previously created, or standardized messages or shortcuts that may be easily selected, may be tailored for a specific geographical location and purpose, to thereby more easily route by filtering as required. Such an arrangement may enable specific service response system 160 groups to only receive the messages relevant to that back end group. Such back end directed messages may be displayed to the group that is appropriate without any effort by the sending user, either front end 102 or service response system 160.

Authentication and/or Validation Network Examples

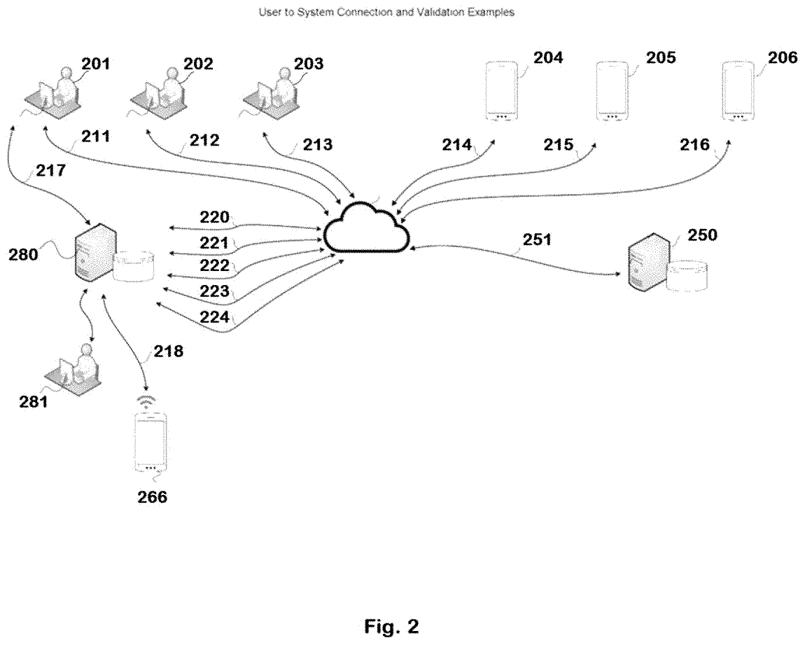

FIG. 2, shows examples of types of validation and logins from the service response system perspective that establish the validity of the front end wireless users and when appropriate the location of the front end wireless users.

201 is an example front end wireless user on a wired local or wide area network connection 211 with access to the Internet 290 with an external IP address that is registered and pre-approved, in a known location, in the system 280 by the System Administrator 281.

201 is an example front end wireless user on a wired local or wide area network connection 217, where the “service response system” 280 is installed and connected to the same local or wide area network as the user.

266 is an example front end wireless user on a wireless local or wide area network connection 218, where the “service response system” 280 is installed and connected to the same local or wide area network as the user.

202 is an example front end wireless user on a wired local area network connection with access to the Internet 290 with an external IP address that is not registered or pre-approved, where access is allowed or rejected based on other login requirements established in the system 280 by the System Administrator 281.

203 is an example front end user on a wired local area network connection with access to the Internet 290 with an external IP address that may or may not be registered or pre-approved, and where access is allowed or rejected based on specific machine identifiers, such as but not limited to MAC address, or other unique identifiers established in the system 280 by the System Administrator 281.

204 is an example of an example front end wireless user on a wireless local area network connection with access to the Internet with an external IP address that is registered and pre-approved, in a known location, in the system 280 by the System Administrator 281.

205 is an example of an example front end wireless user on a wireless connection with access to the Internet with an external IP address that is not registered or pre-approved, where access is allowed or rejected based on other login requirements established in the system 280 by the System Administrator 281.

206 is an example of an example front end wireless user on any type of wireless connection, such as Bluetooth, with access to the Internet with an external IP address that is registered or pre-approved, where access is allowed or rejected based on other login requirements established in the system 280 by the System Administrator 281.

In the example, the connection 211 established for the user 201 by the system 280 is further validated by establishing the user location using the validation process 220. This process 220 can also establish the user location based on a known IP address or parameters passed in the URL which begins the login process. These parameters can establish the location and sub location of the user as described herein, or by any known methods of location identification. This process 220 may also establish the user location based on geo-code information provided by the devices Global Positioning System, as described herein. This geo-code may establish the location and sub location of the user.

The connection established for the user by the system 211 may be further validated by establishing the user permissions using the validation process 221.

The connection established for the user by the system 211 may be further validated by establishing the user interface screens which may be assign by user type, permission, location, and login credentials using the validation process 222.

The connection established for the user by the system may be further validated by using any multifactor authentication method 223 that is pre-established in system 280, which can further establish the validity of the user beyond a login id and password.

The connection established for the user by the system may be further validated by using SMS text 224 that is based on the phone number provided by the user which can further establish the that the user is in physical control of the device attempting login.

The connection established for the user by the system 211 may be further validated by establishing the appropriate data to display based on the permissions pre-established by the administrator 281 or another user (202, 203, 204, 205, 206, 266). Any of the above validation and/or authentication methods or steps may be used in addition to one another, alone, or in any combination of the above or other steps. By describing some example authentication and/or validation steps in FIG. 2, in no way limits the methods of validation and/or authentication of front end wireless or wired devices, by the systems described herein.

User to System Connection and Validation Examples

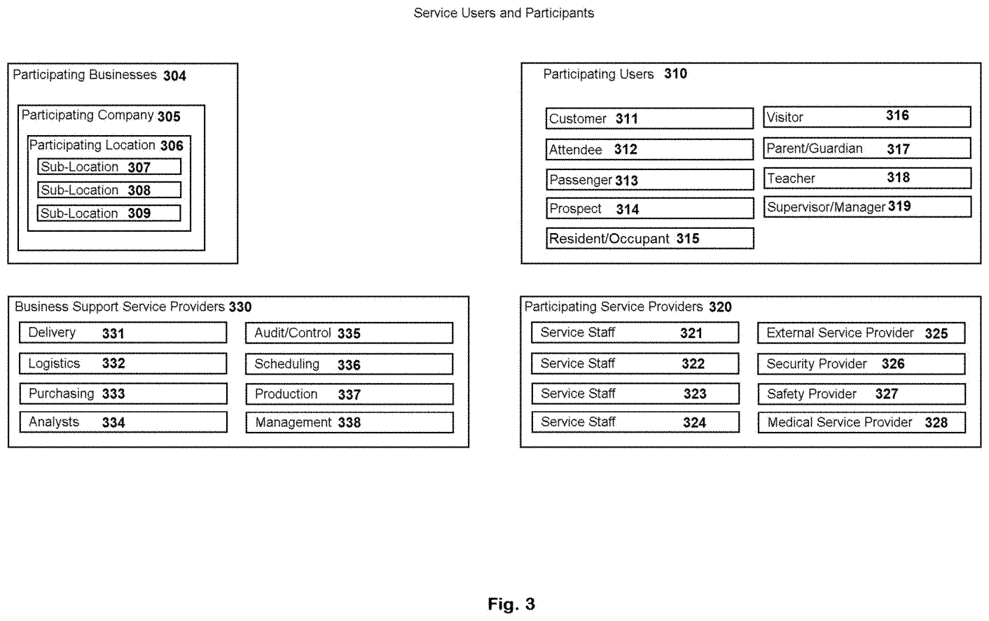

FIG. 3, shows examples of the types of front end users, participants and service responders enabled by the systems and methods described herein. Further described below how each front end user, participant or service responders may benefit from the systems and methods by overcoming existing limitations and obstacles.

The number and type of organizations 304 that could benefit by participation in the systems and methods here, is unlimited. Each organization could have multiple companies 305, unlimited locations 306, and unlimited sub locations 307.

Each participating organization may have participating users 310 at any level of the organization structure 305, location 306 or sub locations 307.

Each participating organization can have participating service providers/responders 320 at any level of the organization structure 305, location 306 or sub locations 307, And may include service staff 321 which may be employees of the participating organization and/or external service providers (325, 326, 327, 328) which can benefit from participation in the solution provided by the systems and methods here.

Service providers/responders 331 that are responsible for the delivery of products or services may benefit from the systems and methods here by enabling the communication and requests from front end users for their services. Without the benefit of the systems and methods, users 310 or service providers/responders 320 may be required to specifically address messages to the delivery provider/responder and arrange for the product or services specified. Product or services specified may then be paid for in advance or at the time of delivery, and the location of the requesting user must be clearly communicated to enable the delivery process. By contrast, the systems and methods here, would eliminate the need for the requesting front end user 310 to find the appropriate address for the service provider 331, communicate the order details, and communicate the pickup or delivery location, since the single request for an item or service may be automatically routed and simply provides the delivery service provider the pickup/delivery location and the list of what is to be picked up or delivered.

A service provider/responder 332 that is responsible for logistics to ensure the availability of products or services at a specific location 306 or sub location 307 may collect information about existing orders and/or consumption to plan the movement of products and services to effectively and efficiently manage inventory and service response times. The solution enabled by the systems and methods here, may provide reporting to logistics providers to show the consumption of products and services by location or sub-location, to enable logistics decisions in real time.

A service provider/responder 333 that is responsible for purchasing to ensure the availability of raw materials, ingredients, tools, or special skills for the production of products or services may need to collect information about existing orders or fulfillment to plan the procurement of products and services to effectively and efficiently manage inventory and service response times. The solution enabled by the systems and methods here, may provide reporting to the purchasing function to show the consumption of products and services by location or sub-location, to enable purchasing decisions in real time.

Thus, a service provider/responder 334 that is responsible for analyzing the performance of the business processes can better understand the performance of the business processes and the impact of a variety of data elements, including but not limited to, customer data, location data, weather data, product data, pricing data, promotion data, discount data, transaction timing data, etc. By collecting and analyzing the data made possible by the solution enabled by the systems and methods here, that contains the complete front end user experience, the analysis and resulting decisions can be significantly improved over current systems that do not capture the full front end user experience in real-time.

A service provider/responder 335 that is responsible for auditing and controlling the accuracy of the services and transactions provided by the business, can track data about each individual transaction, and easily communicate to individual front end users regarding the transaction, including direct front end user communication to gather details about the transaction. This ability to enable the audit and control process directly into the full front end user engagement, is made possible by the solution enabled by the systems and methods here. Typically, the audit function is a post transaction process and requires significant research to identify issues and interview participants in the transaction to draw conclusions about the issues or concerns regarding the integrity of any given transaction.

A service provider/responder 336 that is responsible for scheduling of the business operations to maximize the potential and front end user satisfaction, often do not have detail transaction and front end user engagement data available in real-time to optimize the performance of the services provided. The capabilities of the production scheduler may be enhanced because the systems and methods here provide a detailed understanding of the complete front end user experience, including front end user survey data, high level transaction timing, and not just performance data.

A service provider/user 337 that is responsible for the production of products, to maximize the business potential and customer or front end user satisfaction, may be impacted in any delay in information about customer or front end user demand or satisfaction. Participation in the services enabled by the invention, dramatically reduces the delay in this demand data and enables real-time data regarding customer or front end user satisfaction. Since, using the systems and methods here enables all customers or front end users to make their requests simultaneously, near-simultaneously, or in close proximity, this provides demand data instantly, or quickly, where current systems might provide the number of customers in line waiting to order, or delay demand data while customers are waiting for availability and engagement with an order taker.

A service provider/responder 338 that is responsible for the management of some aspect of the organization, to maximize the business potential and customer or front end user satisfaction, may be impacted in any delay in information about customer or front end user demand or satisfaction. Participation in the services enabled by the systems and methods here, may reduce the delay in the full customer or front end user experience and enables real-time data regarding business performance and customer or front end user satisfaction.

Each participating organization may have support service providers 330 at any level of the structure 305, location 306 or sub locations 307. These external service providers/responders 330 may benefit from participation in the solution provided by the systems and methods hereby enabling their service to the front end users 310 by overcoming existing limitations and obstacles in providing their services to the front end users.

Personnel involved in the fulfillment or delivery of products and services for the organization may have varied responsibilities and different information is needed for each job type. These personnel referred to in FIG. 3 as service staff (321, 322, 333, 344), typically receive their instructions for the actions required in the fulfillment of their services in separate systems or even manually or by direct verbal instruction. For example, in a restaurant environment service staff 321 maybe kitchen personnel responsible for making salads. They must receive specific instructions in real time to coordinate the fulfillment of their responsibility in conjunction with the rest of the food order. Each member of the kitchen staff may have different production responsibilities such as a line cook may be service staff 322 and a fry cook maybe service staff 323. Each service staff member, as a participant in the service is enabled by the invention and could receive individual instructions for their actions required to fulfill the orders within a single system and could communicate with the customer directly on any questions regarding the individual items. While this is a non-limiting example, the solution enabled by the systems and methods here may provide individualized information from single or multiple requests directly from the front end user without intervention, while enabling direct communication back to the requesting customer.

Not all participating service providers/responders 320 may be involved in the commercial activities of the organization engagement with the front end users. Communications enabled by the systems and methods here may be used to facilitate direct communication, needs or concerns to a security entity 326, a safety entity 327, or a medical service provider 328. Not limited to these examples, any external service provider/responder 325 could be a participant and the solution enabled by the systems and methods here. Other examples might include utility providers, service station attendants, waste collection services, fire department services or any external service provider that could benefit the requesting user by eliminating delay of the communication of the need. In the current environment without the use of the systems and methods here, it is necessary for the user providing notification of an urgent event or need to look up or somehow discover the best communication path such as phone number or email address for the specific services required, and in many cases may have no visibility if the urgent event or need has been received. This can increase the amount of time required to reach the required service provider/responder. Additionally, once the service provider/responder is contacted it is typical that a call center must collect information about the user, the issue, and the location of the problem. This is necessary to begin routing the information to the correct available service provider nearest the location of need. The solution enabled by the systems and methods here also facilitate the direct communication between the service providers/responder and the reporting front end user. This communication could include a request for pictures, directed action to take before services arrive, or a link to a separate system to provide additional functionality.

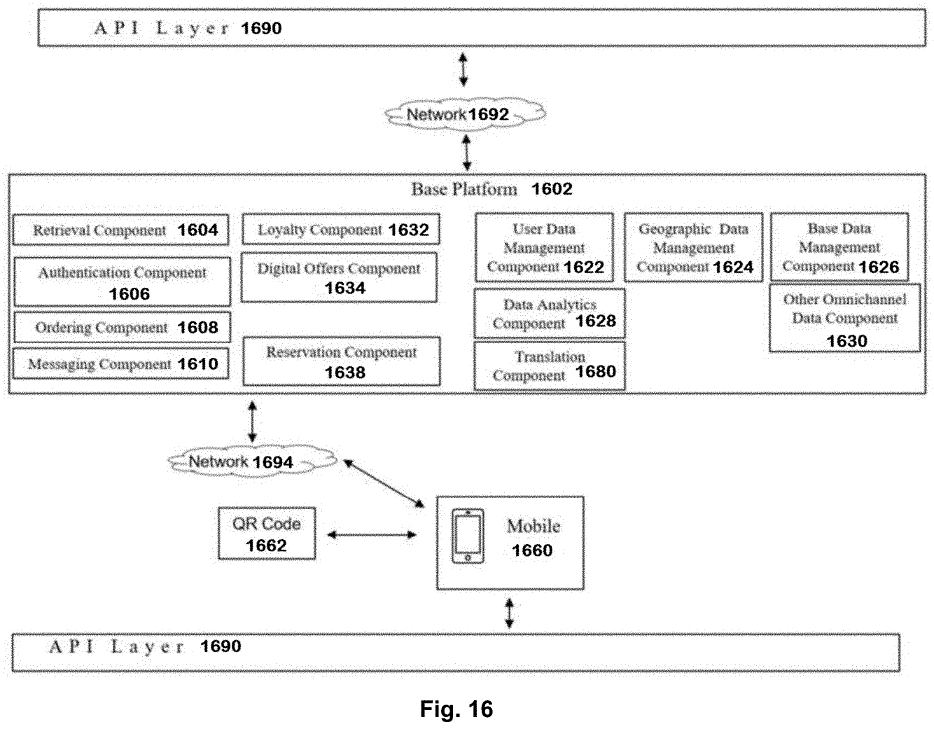

FIG. 3, also shows various users, providers, or participants that might benefit from the components contained in the Base Platform 1602 from FIG. 16. Included in FIG. 3 are Participating Users 310. These Users may interreact with individual or a combination of components found within the Base Platform 1602 in FIG. 16.

FIG. 3, shows an example listing of the Participating Users 310 including a Customer 311. Currently a customer to a restaurant, for example, faces a variety of limiting factors to managing their experience at their own pace. For example, a customer once seated must wait on a server to stop by and take a drink order. The customer must then wait again for the server to come back by to place a food order. Once the food is delivered the customer must get the attention of the service staff to make additional requests like desire for condiments, refills, napkins, etc. Further waiting occurs when a customer is ready to pay, in flagging down the service staff, to request the check. Customer must wait again for the service staff to return with the check. Customer must wait for the service staff to return to collect payment. The customer must then wait a final time for service staff to return with change.

The solution enabled by the systems and methods here streamlines the customers 311 experience allowing the customer to interact and communicate with service staff in real-time immediately upon authentication into the system. Once authenticated the customer can order/pay for food and drinks without waiting on service staff. Any variety of customer requests to enhance the experience like condiments, refills, napkins, request to speak to manager, requests to clean table, etc. can occur immediately. The customer is in control of making any requests of service personnel on their own timetable without any delay. The solution enabled by the systems and methods here also enable the ability for real time bidirectional communication between service personnel and customers. For example, if the service person has a question related to a customer request, they can initiate messaging capability within the system to enable the best possible experience and outcome related to a customer's specific request or the experience as a whole. The systems and methods here also enable greater analytics around the entire customer experience. The customer has visibility to the length of time since making an individual request of service personnel and the ability to track order progress with alerts or timers shown in the customer facing UI.

FIG. 3, shows an example listing of the Participating Users 310 including an Attendee 312. Currently an attendee to a stadium or venue for example faces a variety of limiting factors to managing their experience at their own pace. For example, once an attendee locates their seat, they are limited in ordering capability in many instances to waiting for a vendor to approach nearby, physically getting up from their seat and locating a vendor by walking the concourse vendor areas and waiting in line to be serviced by the food/beverage vendor.

The solution enabled by the systems and methods here, enhances that experience in that an attendee 312 might order food or drink directly from within the system, said order being automatically redirected to the closest vendors to their specific seat location within the venues ecommerce ordering/payment platform. This enables a multitude of capabilities like the ability for an attendee's food/drink order to be delivered to the attendee's specific seat or enabling bidirectional communication between the vendor and attendee to clarify a request or need or perhaps inform an attendee that their food/drink order is ready for pickup at vendor location. In such examples, the attendee may be in control of making any requests of service or vendor personnel on their own timetable without any delay. The solution enabled by the systems and methods here, also enables greater analytics around the entire attendee experience. The attendee has visibility to the length of time since making an individual request of vendor personnel and the ability to track order progress with alerts or timers shown in the attendee facing UI. The system might also enable enhanced safety/security/wellness for attendees giving them the ability to directly communicate with other Participating Service Providers 320 like Security 326, Safety 327 or Medical 328 personnel.

In a safety/security/wellness situation the solution enabled by the systems and methods here enables real time bidirectional communication with service providers and can provide those service personnel real time location of attendee via any number of geo-location methods and techniques.

FIG. 3, shows an example listing of the Participating Users 310 including an Passenger 313. Currently a passenger in an airline flight for example faces a variety of limiting factors to managing their experience at their own pace. For example, once seated a passenger is limited to either waiting for an airline flight attendant to walk by in order to make a request/share information or depending on the specific aircraft the passenger might have the ability to push a button overhead notifying the airline personnel that they need to speak with a flight attendant.

These limitations may be overcome with the solution enabled by the systems and methods here in that once authenticated a passenger 313 can have real time and discrete communication capability with Airline staff while providing airline staff with specific passenger location within the aircraft automatically. Not only might this be useful when requesting a food/beverage/snack/comfort item but perhaps more importantly the ability to discretely notify airline staff of a potential Security/Safety/Medical issue. The solution enabled by the systems and methods here may be used to provide real-time bidirectional communication between airline staff and passengers while providing greater analytics around the entire passenger experience such as time since a specific request was made or GUI notifications within the system that a message has been acknowledged/received.

FIG. 3, shows an example listing of the Participating Users 310 including a Prospect 314. Currently a prospective client or customer for a business faces a variety of limiting factors in a competitive busy environment such as a trade show. One of the largest issues a prospect might have is competing for attention among the hundreds or thousands of other potential vendor business prospects. The systems and methods here would enable a prospect to request additional information from a vendor or business service provider in real time while simultaneously or in close proximity, providing their information to the vendor or provider for follow up. This may help ensure that a busy vendor at a booth is not only notified of a prospects interest in their product or service but enables the capability for bidirectional communication between vendors and prospects to enhance the prospects experience and efficiency at identifying and connecting with potential product or service providers. Systems and methods here may also eliminate the cumbersome process of having the prospect's attendance badge scanned by the vendor or the collection of a business card to enable post show communication or follow-up. Another example at a tradeshow might be a prospects ability to ask questions of participants in an on-stage round table or forum. Once authenticated by the solution enabled by the invention, a prospect might ask a question of on stage or off stage forum participants while instantly providing some applicable background information related to the prospect or prospects business automatically allowing round table participants to tailor a response to a question to an individual prospect circumstance. The messaging capability enabled by the systems and methods here may provide the ability for anyone in the audience to ask questions in real-time without being required to stand in line at a microphone.

FIG. 3, shows an example listing of the Participating Users 310 including the Resident or Occupant of a home or business 315. Currently the resident or occupant of a home or business location faces a variety of limiting factors to the ideal business experience since they would have to search for the contact information for a business from which they would like to order a product or service. For example, the occupant of a home wants to order a product or service to be delivered to their location they are limited in ease of ordering, being required to take the time to search for the contact information for that business or the time to navigate to that business's ecommerce site, or call, or message directly to that business to place an order. This would also require them to provide their address and payment information, taking valuable time and risking miscommunication or the security of the payment information. We eliminate all of these tasks by providing a preconfigured or an adhoc message to the correct business with the pre-assigned geo-code so that the business can receive the order details instantly including routing information to the location. Some businesses offer a mobile app or e-commerce capabilities to improve the process, but it is still necessary to provide login information to start the process and the user must have an app or account for every business they want to use. This solution enables ordering from any business with minimal effort. Depending on the product or service, the user could complete the order with a single tap.

FIG. 3, shows an example listing of the Participating Users 310 including a Visitor 316. Currently visitors to a theme park, for example, face any number of limiting factors to managing their experience at their own pace. Long lines and waits are norms faced by visitors at theme parks. The solution enabled by the systems and methods here may allow for the experience of a visitor to be enhanced. For example, after entering the theme park and authenticating into the system the visitor could be displayed current wait times for lines at major attractions enabling the visitor the ability to choose which attractions to visit in which order based on analytics around current or past trends related to wait times. The system might also enhance that visitor experience in that they might order food or drink directly from within the system which are sent to the closest park vendors to their specific current location within the park. This enables a multitude of capabilities like the ability for a visitor's food/drink order to be delivered to the visitors specific location/delivery area or enabling bidirectional communication between the vendor and attendee to clarify a request or need or perhaps inform a visitor that their food/drink order is ready for pickup at vendor pickup location. The system might also enable enhanced safety/security/wellness for visitors giving them the ability to directly communicate with other Participating Service Providers 320 like Security 326, Safety 327 and Medical 328 providers. In a safety/security/wellness situation the systems and methods here enable real time bidirectional communication with service providers and can provide those service personnel real time location of the reporting visitor via any number of methods and geo-location techniques.

FIG. 3, shows an example listing of the Participating Users 310 including a Parent/Guardian/Patient 317. Currently a Parent/Guardian of a minor receiving medical care at a medical facility, for example, faces any number of limiting factors to managing their child's care and or experience at the medical facility. After Authenticating into the system a Parent/Guardian could engage with Medical providers like doctors and nurses in real time to ask questions and request items. A Parent or Guardian of a child admitted to a hospital room could have the ability to see requests made or needed from their child even if not physically present in the room and monitor or engage in communication with nurse/doctor/patient. The Parent or Guardian could also have visibility to real time analytics related to the care their child is receiving via GUI item or items from within the solution enabled by the systems and methods here. Things like timers related to specific comfort requests or even updates related to ordered tests. The Parent or Guardian can engage in real time bidirectional messaging with providers or request a visit from the doctor or specialist when appropriate. Likewise, a Patient 317 that is of an age that a Parent or Guardian is not required would have the same capabilities listed above in managing their own experience at a medical provider facility.

FIG. 3, shows an example listing of the Participating Users 310 including a Teacher 318. Currently a teacher faces any number of limiting factors to managing their students learning experience. After students/teachers are authenticated into the solution enabled by the systems and methods here, for example, students could engage in discrete real time bidirectional communication with their teacher. Instances where a shy student would not normally engage with a question to the teacher could be overcome with the ability to discretely message the teacher with questions. The solution enabled by the systems and methods here could even assist in administering pop quizzes or tests providing the capability for students to answer questions that could be graded and filed in student gradebook automatically. Instances where a foreign speaking student would not easily engage with a question to the teacher could be overcome with the ability to have the solution translate a message to or from teacher with questions. The teacher can then respond in real time or follow up after class/school with student via messaging system. Grades and results could also be shared with students/parents logged into the system in real time. Teachers could request meetings with either the student or even include student parents in a parent teacher conference request from within the system in which the parent of a student is notified by any number of methods automatically with the ability to respond in real time.

FIG. 3, shows an example listing of the Participating Users 310 including a Supervisor/Manager 319. Currently a supervisor or manager faces any number of limiting factors to managing their employee's work. For example, a restaurant Manager might currently be required to sit and watch either at a table within the restaurant or via camera to collect data related to server/host/hostess performance. In many instances this involves a stopwatch and pen and paper documenting service times related to Operational standards or norms. This may be time consuming and impractical so does not occur as often as a Manager might like. However, once authenticated into the solution enabled by the systems and methods here, the Manager of a restaurant would have access and visibility to up to date real time and past trend analytics related to their customers experience as well as the employee interactions with customers as they fulfill customers experience needs. Managers have access to data driven analytics in which to conduct training and enhance benchmarking capability within their brand or compare their business and employees to the industry as a whole. Managers using the systems and methods here also can dive into specific employee/customer interactions to the detailed level to review message/request history for training purposes or validation of complaints from either customers or employees' point of view. Managers may also engage in bidirectional communication with either guests or employees as required.

Any combination, permutation, alone or in combination of the above could be utilized in platforms using the systems and methods described herein. None of these examples are intended to be limiting, and any combination of the above or additional material may be utilized.

Map Examples

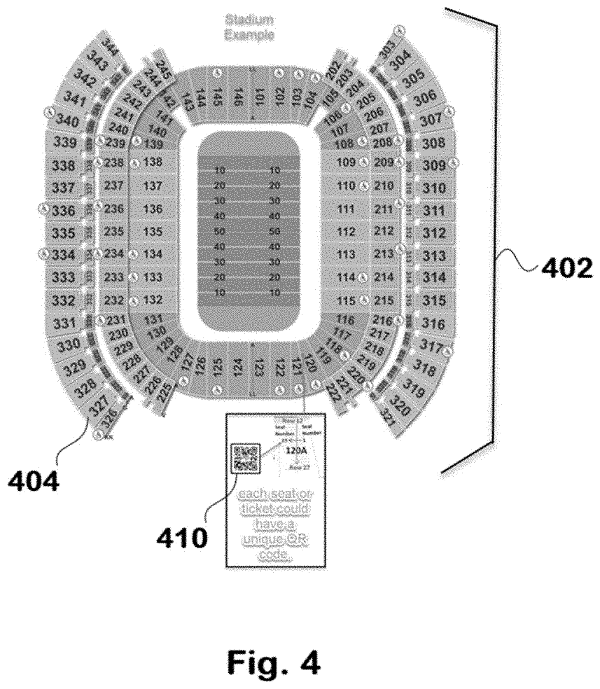

FIG. 4 shows an example map arrangement in accordance with embodiments described herein. In FIG. 4, a map of a stadium is shown 402 with individual sections 404 of seats shown. Inside each section, rows of seats may be arranged, and in some examples as described herein, a geo-code 410 may be affixed to each seat. In some examples, a geo-code may be assigned to a row, section, area, or any kind of sub-location including but not limited to individual seats. The system shown in FIG. 1 may be utilized with the map of stadium seats instead of restaurant tables.

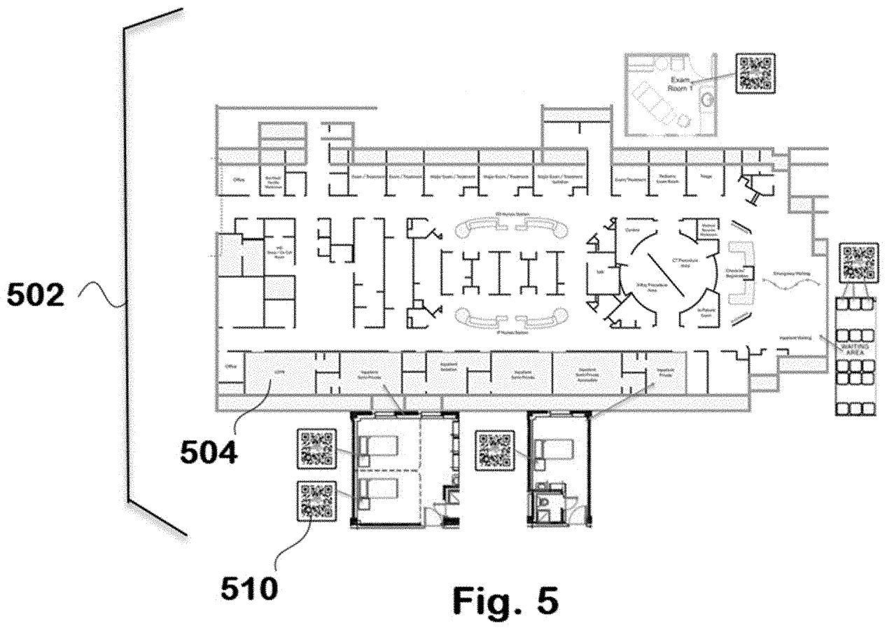

FIG. 5 shows an example map arrangement in accordance with embodiments described herein. In FIG. 5, a map of a hospital is shown 5 02 with individual areas 5 04 of rooms shown. Inside each area, any kind of layout of rooms may be arranged, and in some examples as described herein, a geo-code 510 may be affixed to each room. In some examples, a geo-code may be assigned to a floor, hallway, section, area, or any kind of sub-location including but not limited to individual rooms. The system shown in FIG. 1 may be utilized with the map of hospital rooms instead of restaurant tables.

Authentication Overview

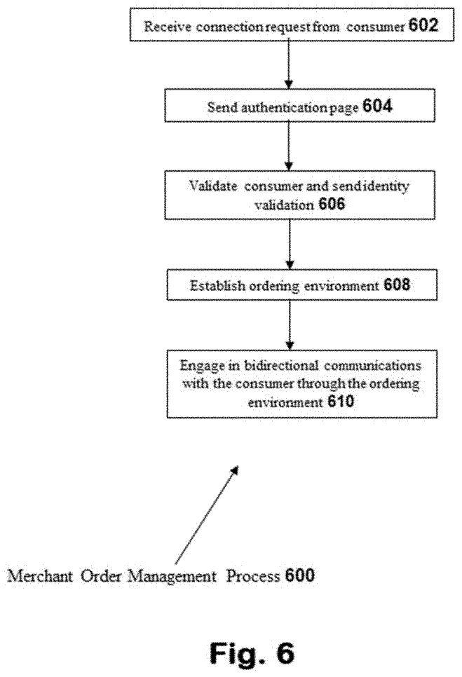

FIG. 6 shows an example flow diagram of authentication sequence as described herein. In FIG. 6, the service response system receives a connection request from a user wireless device 602. The system sends an authentication page to the user wireless device 604. Then the system may send a user authentication status 606. Next, the system may send the main communications page to the user wireless device 608. Finally, the system may allow for access to the enhanced messaging service 610. This authentication example is not intended to be limiting, any number of authentication steps could be used in the systems and methods described herein.

Main Communications Page Examples

The systems and methods here may allow for an enhanced communications suite that is tailored to a specific geographical location and usage, without first selecting a specific SMS, text, or email address for a specific recipient, yet still allow a user to utilize their own smart device, and/or a provided communications hardware platform. The systems and methods here allow specific geographically located users, service response systems, and service response system users to message back and forth in a manner that is structured by previously arranged messages and formatted to ease the arrangement of the message for best response. In some example, adhoc free text messages may be initiated from the service response system side, which then adds the messaging icon to the front end device. In some examples, free-text or adhoc text messages may be allowed from the front end device side as well, additionally or alternatively. In some examples, a request type of “open Service Request” or “kitchen Request” could be created to automatically send a free text message interface to the front end device with a prompt such as a question “how can I help”, etc. Then front end device user could enter adhoc request response as described herein.

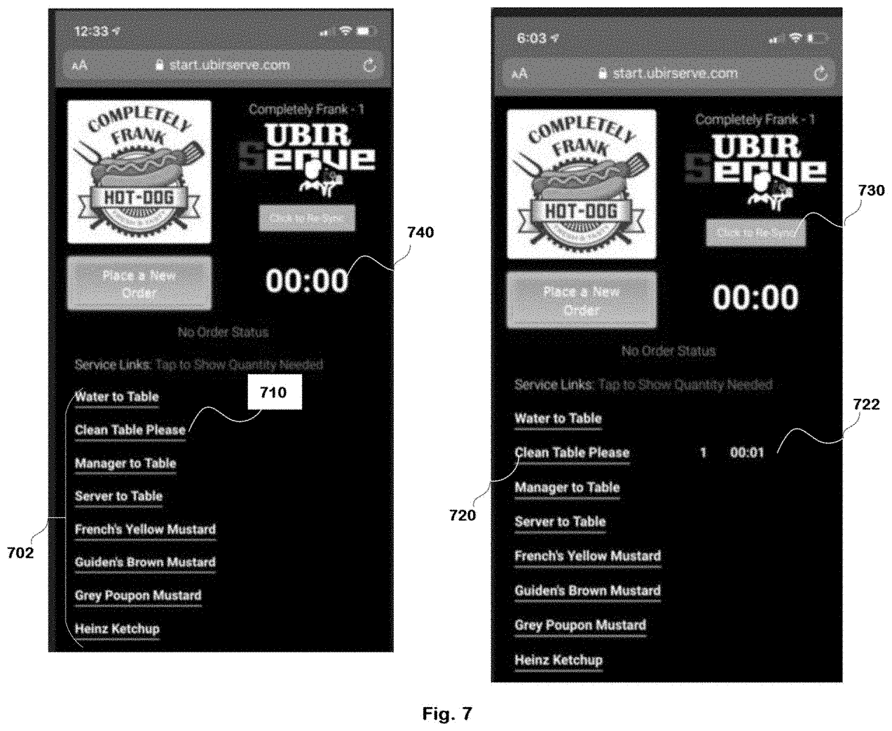

FIGS. 7, 8, and 9 show example screenshots of user interfaces (UIs) as seen by a front end user smartphone or mobile device.

In the context of a restaurant use case, FIG. 7 shows an example of a main communications page with preselected and arranged buttons 710 for communication shortcuts previously determined and arranged on the page for use. In the example, this may be the front end user-facing side of the communications page, allowing communications to be sent to and received from the service response system (160 in FIG. 1) as described herein. In other words, the screen examples depicted in FIG. 7 may be those sent to and displayed by a front end user wireless device (102 in FIG. 1) and/or any kind of wireless device, tablet, phablet, laptop, touchscreen, wearable, or other computing device either sent to a user owned device or provided by a proprietor on premises using webpages sent by the back end system and network (110 and 104 in FIG. 1).

In the restaurant example, a list of commonly utilized message requests 702 may be loaded into the main screen and displayed as buttons, icons, or other message shortcuts. These messages may be any number, and may be accessed by scrolling on the device if the number of requests are more than can fit on a single screen. Such messages may be edited, updated, changed, and/or otherwise deleted or added by a system administrator and/or by the system itself based on the data received regarding usage of such messages and analytics responses as described herein. In some examples, the system re-orders the list based on most commonly utilized messages and pushes the most common to the top of the list 702. In some examples, a system administrator may re-order the messages based on a technical goal to be achieved by the system to ease communication flow. Any pre-loaded messages may be loaded and ordered according to best practices and efficiency for the system, the examples here are not intended to be limiting.

Such an example “clean the table please” 710 may be one of the prearranged shortcut buttons, along with water request, manager request, server request, or specific item request such as mustard or ketchup, or any others. Any number of prearranged button shortcuts 710 may be loaded into the main communications page and be edited and changed by the managers of the network if and when changes are required.

Because the authentication setup described above, has identified that the particular wireless device that is communicating has a specific geographic location and/or sublocation, as identified by the scanned and authenticated geo-tag, the receiver of the communications in the service response group will know where the front end user is physically located and may provide response communications and/or other actions based on the message and location. In some examples, a timer 722 may appear after a pre-arranged button is pressed to communicate to the service response system. In such examples, the back end system may record how long the timer runs before a specific service request and/or message is satisfied, by the receiver of the communication at the service response system. That data may be stored and analyzed as described herein.

In a medical example, a request for a specific medicine to room 402 may be made by a patient or nurse for a robot or human to respond to. The timer 722 may be used for data analytics to see if there are certain patients who are not receiving medicine in a timely manner, if certain robots or staff are not delivering requests in a timely manner, and can be used by an administrator to make efficiency changes to layouts, hubs of items to be delivered, and other logistical arrangements.

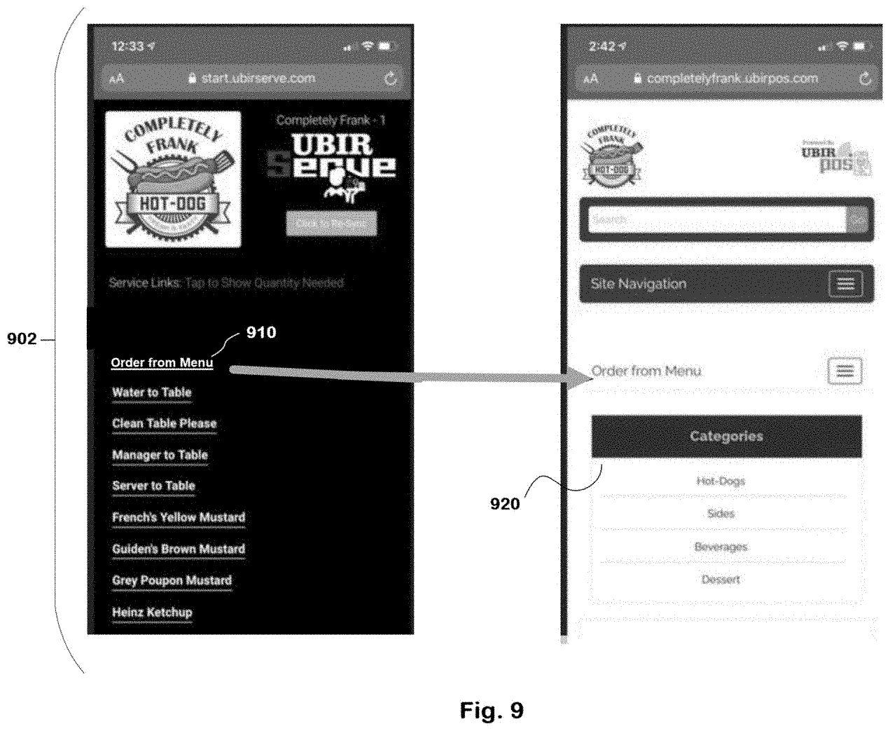

In the example of the main communications page of FIG. 7 another timer 740 may be arranged. In some examples, this timer 740 may be used to time any number of things such as the time of the entire wireless device session, time for a pass-through event or order to take place and be responded to, as described in FIG. 9, or any number of other events as programmed by the system administrator. In some examples, the main timer may be coordinated with access to the pass-through lined website as described herein. In some examples, that may be a restaurant food order timing when the order was placed, or in a medical example, timing when a pharmacy order was placed. Any number of pass-through request timers could be used.

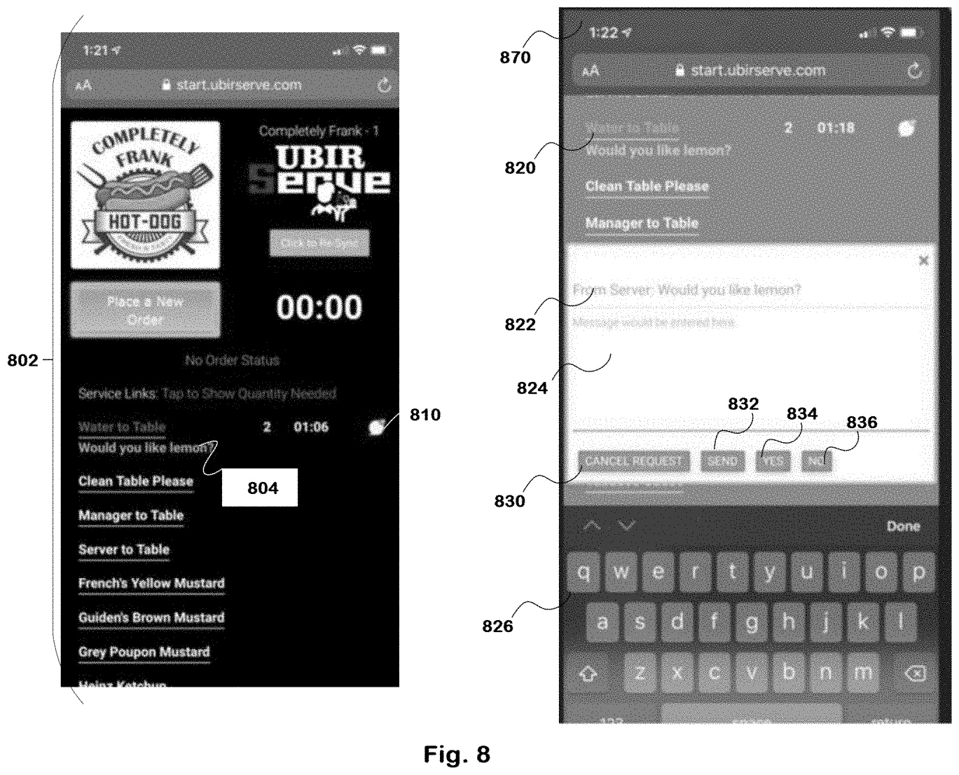

FIG. 8 shows more examples additionally or alternatively that could be used in the communication systems described here. Such sub-messaging system described in FIG. 8 may be accessed from the main communications page of 802 and used to communicate between the front end user in the sub-geography (102 in FIG. 1) and the service response system user group (160 in FIG. 1). In such examples, 810 may be a free text messaging system that may augment communications if the front end user decides that their request or message is different than the pre-loaded message shortcuts. In some examples, the free text examples may supplement a main request made using the pre-loaded messages. In some examples, the free text may include other features such as but not limited to Text reproduced from voice, text reproduced from video; an auditory message; a video message; a photograph; and/or a video.

In the communications example of FIG. 8, the front end user selected on a prearranged communications button shortcut “Water to Table” 804 and the message icon 810 appears on the screen. After clicking the message icon 810, a second free text page is displayed 870. The previously selected button information 820 is shown above a free text response area 822 thereby allowing free text communication between the user 102 in FIG. 1) and the service response system (160 in FIG. 1). In some examples, the service response system 160 in FIG. 1 may be made up of multiple sub-components, each with their own communications hardware system such as a smartphone, tablet, wearable, or other computing device. In such examples, it may be useful to correlate specific pre-loaded button messages with specific sub-components of the back end user group. This would allow for direct messaging to take place between previously established user groups to ease communication flow without the need of addresses to be input for each message.

For example, in a medical hospital example, the message “I need a prescription refill” may be directed only to a pharmacy service response group instead of to the janitorial staff which would have no need for such a message. In some examples, the message may be sent to both the pharmacy service response subgroup and a general practitioner doctor, for safety reasons. In a restaurant example, a request for water may be sent to a wait staff sub unit, whereas a request for a new spoon may be sent to another table setting group. In a warehouse example, a request for a new forklift may be sent to the maintenance group whereas a request for a decision to be made on a late package may go to a management subgroup.

By establishing many multiple subgroups of service response users, and tying the previously loaded message buttons and corresponding free text options to those specific hardware of those service response subunits, the messages may flow to the correct recipient and bypass those recipients who do not require such information, all without the need to input a specific address or identifier, because the system routes the message traffic according to the previously arranged determination. This previously programmed network of message pipelines and/or routes may allow for more efficient communications based on subject matter of the messages and allow for ease of response, cut-down of redundant data storage, and ease use of all the systems for both front end users and service response system users.

A free text message response box 824 is shown along with a keyboard 826 for text entry directed at the specific service response subgroups as described herein. After entry, the front end user may select other previously arranged action buttons or shortcuts such as but not limited to “Cancel Request” 830, “Send” 832, and shortcuts for quick response such as “Yes” 834 and “No” 836. These messages may be sent in FIG. 1 between the wireless device 102 and the service response system 160 in FIG. 1.

Pass Through Portal Examples

FIG. 9 shows another example, additionally or alternatively, of features that may be utilized from the main communications page 902. In the example, FIG. 9, a pass-through button 910 is arranged on the screen. Such a pass-through button may allow for the network 110 in FIG. 1 to utilize additional back-end websites for industry specific goals by communication through a wide area network such as the Internet. In such an example, the service response system may link the user to other third-party websites that deal with the underlying industry of the specific geographic location where the user is located, thereby expanding the functionality available to the user, but conveniently and efficiently located on the main communications screen 902 utilized for all of the geographic specific communications as described herein.

For example, in the warehouse context, the pass-through button 910 may allow for a user to search inventory by linking to the main warehouse company proprietary inventory page. In a medical example, the pass-through button 910 may allow the user to view the hospital's online scheduling system to see what staff are working at what time. In a restaurant example, the pass-through button 910 may allow a user to go straight through to the restaurant's online ordering system. Any kind of through-pass arrangement may be made such that the user is seamlessly connected with a website that is useful in the context of their geographic location and industry practice, and allow the user to feel as if they are still in the same networking infrastructure, but in reality they have been sent to another server that hosts a different website.

In some examples, additionally or alternatively, the hosting of the pass-through websites may be different than the hosting of the communications system described herein. Such a pass-through website could host any kind of viewing of media, ordering of food or products, map system, sports scores, or other online features and functionality.

In some examples, multiple pass-through buttons 910 may be arranged on the main communications system that could be arranged for multiple features. In the warehouse context, it may link through to a security camera system and also an online scheduling system. In a medical context, it may link to the pharmacy ordering page, the online scheduling arrangement for nurses, and also a media page allowing for viewing of television or internet streaming media. In a restaurant context it may link through to an online food ordering page 920 and a sports media page allowing for streaming video of sports games. Any number of pass-through link buttons may be arranged on the main communications page, and no examples here are intended to be limiting.

This arrangement may allow for a robust website interface with many multiple functionalities to be viewed and accessed by a user, while still allowing the local network administrator to concentrate on the local communications systems and not the underlying website that may already be in existence and operated/hosted by a larger company with industry specific needs.

Service Response System Communications Examples

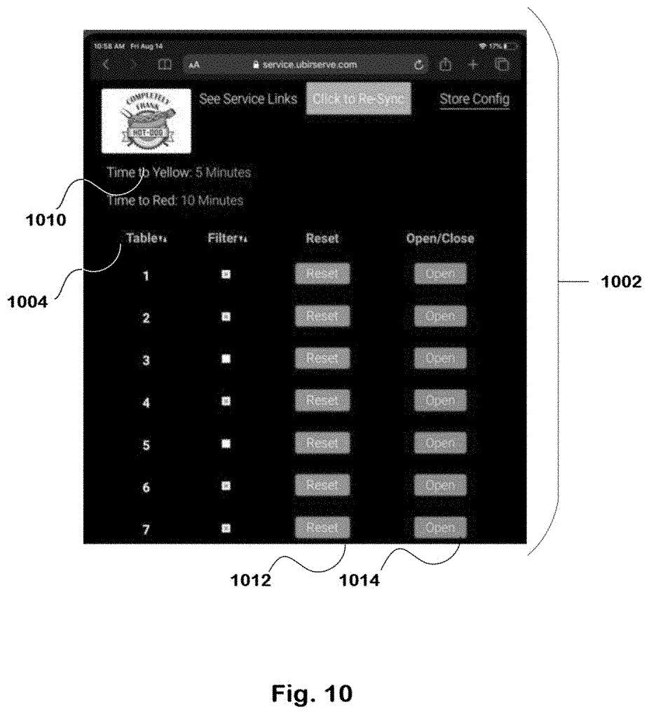

FIGS. 10-14, show examples of the systems and methods from the service response system perspective that is operating to help service the user of the mobile wireless device system described herein.

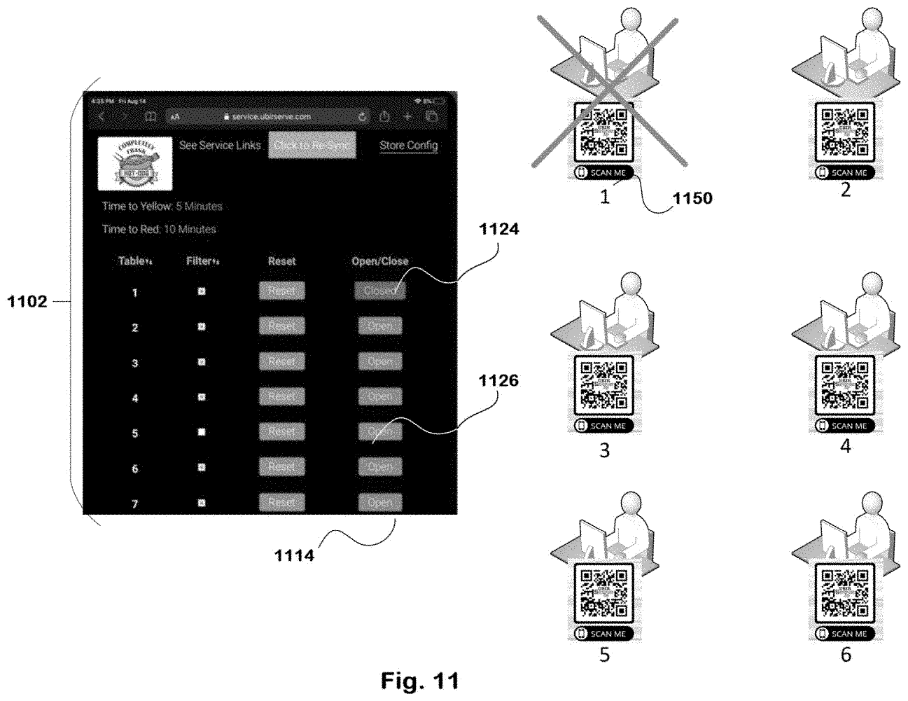

FIG. 10 shows an example of a service response system UI that allow the service response system users to view the overall main communication coordination page. The layout page 1002 allows the service response system user to see the breakdown of the geographical subunits 1004 laid out in rows. Each of these geographical subunits 1004 correlates to the barcode or QR code (120 and 122) established by the system. The page allows for the service response system user to see the rules that are loaded into the system in terms of the timing indicators. In the example 1002 shows “time to yellow 5 minutes” and “time to red 10 minutes” 1010—these are rules established by an administrator that can allow the system to be adapted for the use. For example, it may be that the system administrator wants a yellow timer to change at 30 minutes for a hospital and 5 minutes for a restaurant. FIG. 10 also shows the ability for a service response system user to Reset 1012 and Open/Close 1014 a geographical subunit as described in FIG. 11.

FIG. 11 shows an example UI 1102 of the system allowing a back end user to turn on and off the geographic subunits by pressing buttons for open/closed 1114. As shown in FIG. 11 the system allows for the service response system user side to be able to close geo-codes such as barcode/QR codes from logging into the system by deselecting that button 1124. FIG. 11 shows the ability to Open or Close a table, room, section, area, or otherwise designated geographical subsection. For example, in the example of FIG. 11, the service response system user has selected “closed” 1124 for table 1, 1150. This means that if a front end user were to scan the QR or barcode at Table 1, 1150, the system would not allow them to authenticate. In some examples, a message or page may be sent to the wireless device that attempted to log in at Table 1 indicating that Table 1 is not open. In some examples, the system may send a message or page to the wireless device that attempted to log in at Table 1 and indicate other tables that are open for services, based on the information from the service response system shown in 1102.

By so doing, users who scan or capture the QR or barcodes correlated to the geographical subunits that are designated as “Closed” will not be able to log into the system as described herein. In order to communicate, that user would have to login at a different geo-code such as barcode or QR code that is toggled Open 1126. Any number of open/closed geographical subunits may be thereby activated as open or turned off as closed by the service response system user through the example back end communications setup page 1102.

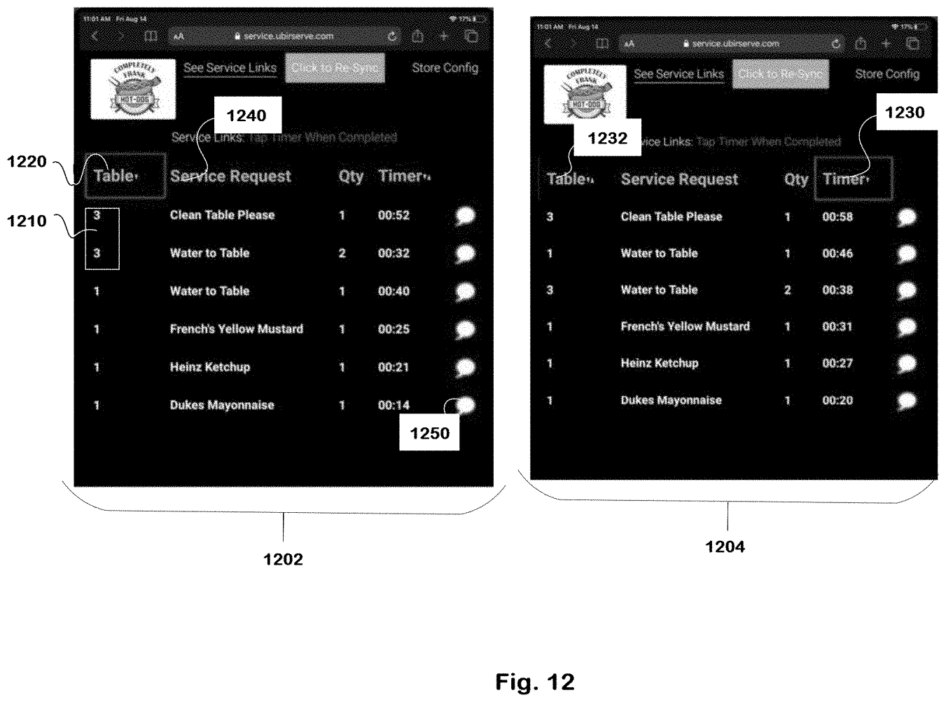

FIG. 12 shows an example of a service response system communications hub UI, 1202. The example shows many different possibilities of communications topics for the service response system to display for a service response system user, for example, the message pre-loaded options 1240. And as described earlier, these messages may already have been filtered to the specific service response system display to which it is best correlated. In such an example, there may exist more communications from front end users to service response systems than is displayed in 1202, but the system has already filtered those messages and directed them to different sub-units of service response system user displays for efficiency purposes.

But this filtering system may not be enough to effectively display the messages coming from front end users to the service response systems, even if they are directed only to the specific service response system that is best suited to respond. For example, as in FIG. 12, 1202, many different communications may be sent in from many various front end users to a service response system, the system may allow for many different ways for a service response system user to aggregate, order, group, or otherwise streamline the communications to allow for efficiency of use. Here, many requests are coming into this one service response system subunit 1202 and more ordering or aggregation is useful for efficiency purposes.

In the example of FIG. 12, the example 1202 shows the ability for the service response system provider to order the incoming communication requests 1240. In the example of 1202, the service response system user has selected the “Table” or geographic subunit 1220 with which to order the incoming requests. By selecting the geographical subunit selection, Table 1220 in this example, the system groups all the similarly received messages for the individual, unique geographical subunits as described herein 1210. This allows a service response system user to view the incoming messages and be able to react or respond according to the grouped messages. As can be seen in 1202, because the geographical subunit is selected, the timer column is not in order. This is because messages received by time are first ordered by geographical subunit 1220 and then by time.

In the second example, 1204, the service response system user has selected the “Timer” option 1230 for ordering the incoming communications. In the example, the system responds by ordering the incoming messages according to the longest waiting request by moving those to the top and the most recent placed messages at the bottom. As can be seen in 1204, by ordering the longest pending requests, the geographical subunits 1232 are now out of order.

Any kind of ordering, aggregating, grouping, or other system may be utilized to increase efficiency on the back end. In some examples, algorithms may be used to populate and order the incoming requests based on previously programmed emphasis issues for the geographical location and industry. For example, a request for a nurse at a hospital may always be programmed to be ordered at the top of the list, whereas an order for a new pillow may be ordered last. The industry specific or geographical specific rules may be established, changed, edited, or otherwise modified by a system administrator to allow for customization. As shown in FIG. 12, the message interface 1250 is also accessible through this page for the service response system users.

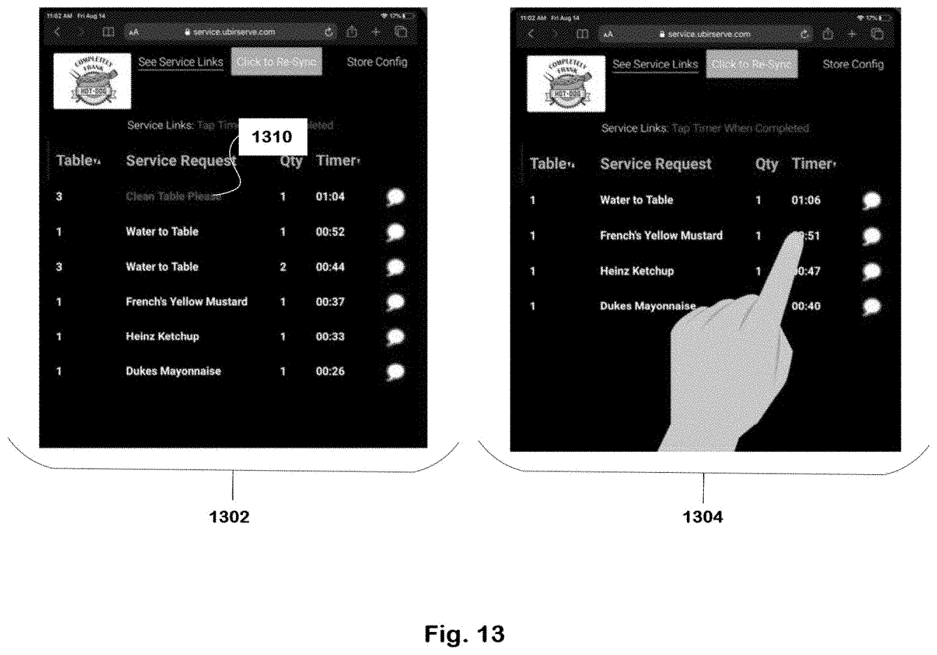

FIG. 13 shows the service response system communications hub UI 1302 where a service response system user has selected one of the service requests as having been acknowledged and actively being worked 1310. The system may then indicate that this message has been acknowledged by changing its color or adding a box or icon for the users or other service personnel to perceive that the message no longer needs attention. FIG. 13 screen 1304 shows that the selected request is no longer in the queue and has disappeared either after a preselected amount of time after it was acknowledged or after being closed manually by the service personnel via clicking a designated item from the GUI that has the designated functionality of closing a service request.

In some examples, the service request 1310 may disappear from the UI when the Timer field is selected on the service response system, designating that the request has been completed. In some examples the response item UI changes color, such as turns green, after it is received on the service response system and the service request name 1310 is selected. In such examples, the UI colors may change to indicate a status change, such as changing to yellow, then red based on the timer if not completed before the preset aging timer threshold.

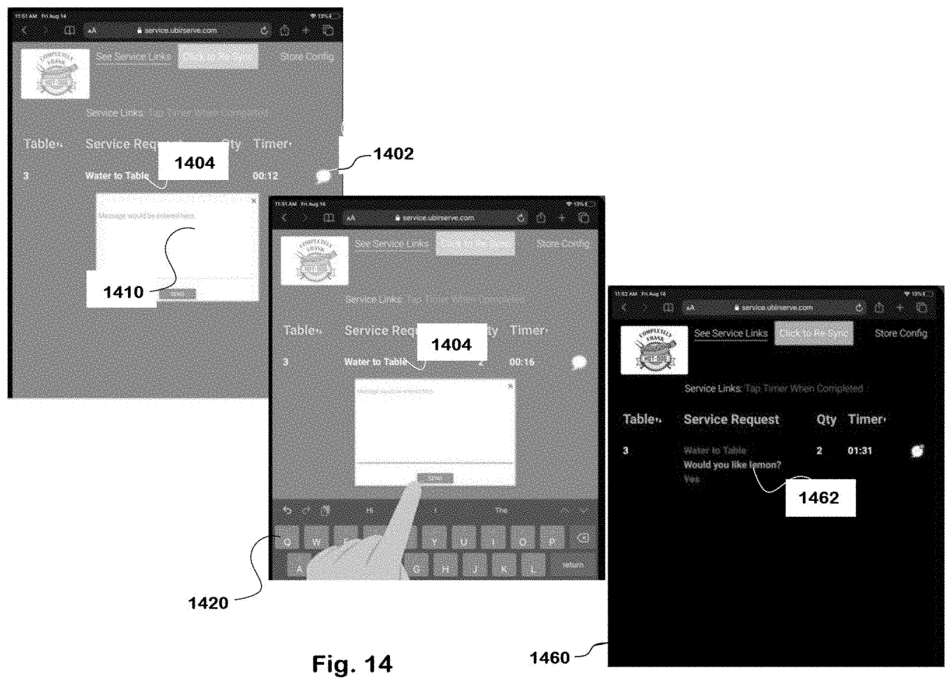

FIG. 14 shows more examples of the free text message entry and display, this time from the service response system perspective. In FIG. 14, the service response system user has selected the free text message icon 1402 corresponding to a specific incoming message 1404 from a front end user. This selection causes a free text entry box to appear 1410. The service response system user is presented with a keyboard 1420 and may type any free text message to respond to the incoming user message 1404.

Reverting back to the front end user UI screen 1460 shows an example of the back and forth free text messages 1462 displayed for the front end user as sent by that front end user and responded to by the service response system user subunit.

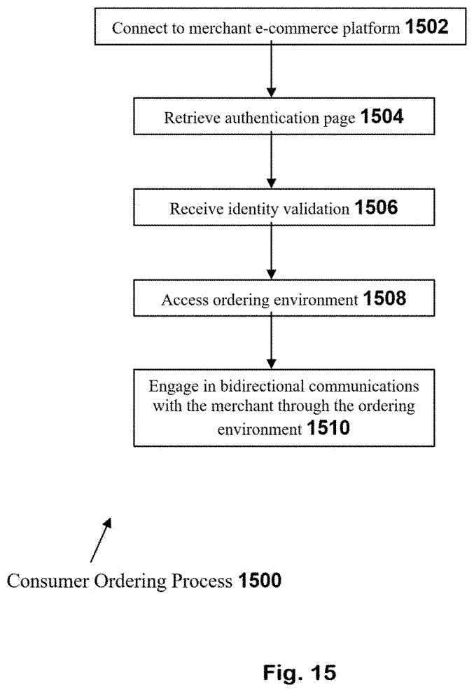

FIG. 15 shows a user ordering process adapted to facilitate transactions between a user and a back end system at a geographic location 1500. In the example, the system connects to the merchant e-commerce platform and the user front end device 1502. Next, the system retrieves an authentication page 1504 for sending to the front end device. Next the system receives identity validation 1506 from the user on the front end device to authenticate. Next the system allows the user on the front end device to access the ordering environment 1508. Next the system allows bidirectional communications with the merchant and user of the front end device through the ordering environment 1510.

Architecture Examples

FIG. 16 shows an exemplary architecture of a platform in accordance with embodiments described herein and may be used to carry out the methods described. FIG. 16 shows an example electronic computer platform 1602. Such a system may be deployed by any number of service response systems including but not limited to a merchant, restaurant, hospital, warehouse, or any other use case example. Such a system may be deployed on-site at the geographic location as discussed herein, and/or be networked to the system and be physically located in another location. The system 1602 could be a one-off deployment or one of a chain of systems deployed at various geographic locations. Example merchants could include large department store operators such as but not limited to Macy's, Walmart, Target, large gas station operators such as but not limited to Chevron, ExxonMobil, Shell), large fast food chains or franchises such as but not limited to McDonald's, In-N-Out Burger, and so on. Other examples of service response system operators may include but are not limited to retail store, hotel, motel, other lodging or hospitality facility, restaurant location, quick service restaurant location, coffee shop, pizzeria, bar, liquor store, grocery store, ice cream shop, frozen yogurt shop, convenience store, gasoline station, electric car charging station, stadium, movie theater, concert hall, other music or live performance facility, winery, medical office, Governmental office (e.g., a Governmental facility that sells, distributes or otherwise offers permits, licenses, vehicular license plates, or other services), hospital, pharmacy or drug store, supermarket, car wash, and/or any combination of the foregoing, planes, trains, ships, vessels, warehouse, etc.

The example back end electronic platform 1602 may comprise components from FIG. 16 such as but not limited to Retrieval component 1604 that may include functionality for processing an authentication page, sending or receiving pages displayed in a mobile app such as a page displayed via a web browser, the mobile app or the web browser could be displayed to the end user via any mobile device (including a mobile phone, wearable device, tablet, etc.). Other components may include an Authentication component 1606 which may include functionality for authenticating a user based on the authentication page. Authentication could include features such as but not limited to Password access; Biometric authentication (including facial recognition or fingerprint); Cookie management; Prestored credit card numbers; Prestored tokenized information such as tokenized payment card, or other tokenized user information such as but not limited to a name, account number, etc.; Mobile phone info (e.g., MAC address, IP address).

Some example embodiments may include a separate ordering component 1608 if such features are not included in a pass-through access tunnel. In examples with ordering components, features may include functionality for processing an electronic ordering interface corresponding to a merchant location, wherein the electronic ordering interface includes functionality for processing the order of the item, this could be a link to an actual ordering environment in a pass-through example or it could be an ordering environment or a part of an ordering environment. An Experience enhancer request could also be made and could include, a request relating to the comfort of the user; a request for an item a complaint, a commendation, some other need of the user.

FIG. 16 shows an example hardware/software architecture which may be utilized to practice the communications systems and methods described herein. In the example, a Base Platform 1602 includes many various components, which may be optional, additional, or alternatively arranged. The Base Platform 1602 may be in communication by a Network 1692 to an API Layer 1690. The Base Platform 1602 may be in communication by a local network 1694 to a Mobile smart device 1660 and its own API Layer 1690. In some examples, a QR code 1662, barcode, or other visual identifier may be utilized as described herein, to prompt an application running on the Mobile smart device 1660 to access a service response system by the API Layer 1690 and thereby send and receive communications germane to the geographic location of the QR Code 1662.

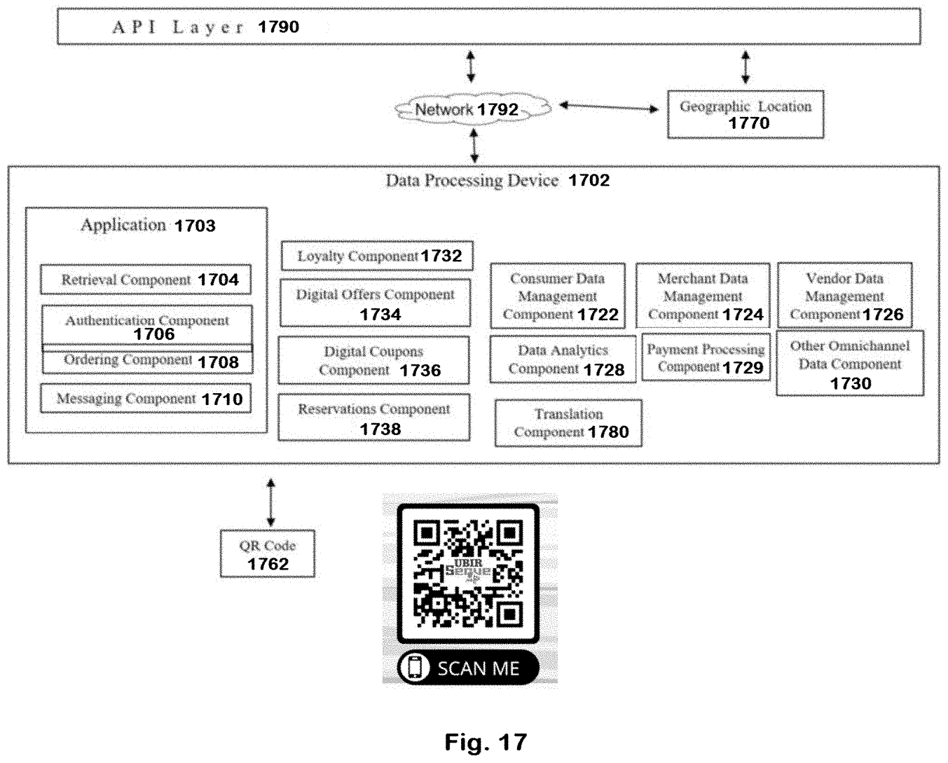

The Base Platform 1602 may include any number of components, additionally, or alternatively in any combination, including but not limited to a retrieval component 1604, authentication component 1606, ordering component 1608, messaging component 1610, user data management component 1622, geographic data management component 1624, Base data management component 1626, data analytics component 1628, and other omnichannel data component 1630, or key performance indicator KPIs and reporting framework. Additional components may include a digital offers component 1634, Translation component 1680, and/or reservation component 1638, and in some examples, a waitlist component additionally or alternatively. In some examples, the 1638 box may be a Reservation or Wait List Component and in some examples embodiments may be the same in FIG. 17 for 1738

Example Architecture

FIG. 17 shows an exemplary architecture of a data processing device in accordance with an embodiment. In the example, the Data Processing Device 1702 is in communication with an API Layer 1790 over a network 1792. The geographic location 1770 of the data processing device 1702 is reported to the API Layer 1790.

The data processing device 1702 could be any number of computers capable of wired or wireless communications such as but not limited to a smartphone, tablet, phablet, wearable watch or other device. The data processing device 1702 is configured to be capable of working with a device camera for capturing an image of a geo-code such as a QR code or barcode 1762 as described herein.

The data processing device 1702 may be configured with many multiple components which may be software applications or code running on the hardware of the data processing device, or a combination of hardware and software systems. Some examples of applications 1703 may include retrieval components 1704, authentication components 1706, ordering components 1706 and/or messaging components 1710 as described herein. In some examples, other components may be added or included additionally or alternatively, in any combination, including a loyalty component 1732, a digital offers component 1734, a digital coupon component 1736, a reservations component 1738 that may or may not contain wait list functionality, a consumer data management component 1722, a data analytics component 1728, a merchant data management component 1724, vendor data management component 1726, payment processing component 1729, Translation component 1780, and/or other omnichannel data component 1730 in any combination or permutation. Such systems of hardware and software may be used to carry out the systems and methods described herein, as described. In some examples, a waitlist component additionally or alternatively may be utilized.

Analytics Examples

The systems and methods here may be used to record, store, and/or save data regarding the various messaging interactions described herein. For example, data regarding identities of every front end device that logs into the system may be saved. Such identifying information may be a MAC address, IP address, serial number, login user name, or other identifying features. Corresponding date and/or time data of every session may be stored and correlated to the device identifier in the service response systems as described.

Such data storage may be in any database such as but not limited to local, distributed, and/or cloud based data storage.

In some examples, additionally or alternatively, data regarding the messages themselves may be recorded and stored. Message data may be correlated in the database for the geo-code associated with the device that sent and received messages with the service response systems. Such data may allow system administrators to analyze message traffic in the geography of the local network, and also to get more granular down to the geographic subunits that are associated or correlated with the geo-tags as described herein. Such data may be fed into algorithms to help determine the most common previously determined message shortcuts that are selected by users of front end devices and may order the shortcuts for later main communication pages. Still other actions may be taken based on the data regarding the message traffic and are not limited to those explicitly described herein.

In some examples, data regarding user experience of front end user devices, based on the service response system timing and correlated to back end users, front end wireless users, any known demographic information known about the front end wireless users, geographic location of the wireless network, geographic subunits within the local wireless network, or any other combination of variables.

Data analytics may include breakdowns of time of service, pass-through data regarding order choices, back end ingredient lists based on pass-through order, not only ingredient lists, but barcoded specific lots of produce, grains, stock, meats, etc. in order to be able to trace end-to-end pathogen transmission.

Data tracing may include contact tracing between users of front end devices for any kind of tracking such as but not limited to pathogen contact tracking, COVID contact tracking at specific geographical locations, and geographical sub-units at specific times to correlate known positive cases with other users known to be geographically nearby and what service response system users were in contact or near the positive user. Data may be recorded for food borne illness breakouts, by tracking message traffic and pass-through order data for known tainted food served within a specific local wireless network. Data regarding location and timing of logged in front end units can be correlated to other location and timing of other logged in front end units, and when information of a known pathogen or COVID positive are found, the system may determine other nearby users, within a set distance at the same time and larger geographical location, and identify those front end devices, and service response devices. By so doing, the system may generate a pathogen contact report identifying other users who were near or in contact with the positive case, including but not limited to back end staff, hospital staff, wait staff, security staff, janitorial staff, or any other kind of user interaction.

In some examples, Internet of Things coupled with 4G and/or 5G wireless networks or any future standard of wireless interconnectivity and communications may be utilized within range of the systems to track any number of items in the geographical location and correlate that information with message traffic and geo-location as described herein.

Machine learning (ML) and/or artificial intelligence (AI) may be utilized to review message traffic to and from front end wireless system users and service response systems. Reports may be generated by the ML/AI based on trends of data lines, message traffic and correlations to geographical locations and geographical subunits of front end devices and time of messages. In a hospital example, if many patients send messages regarding the temperature of their room being too cold within a certain geographical subunit, a report may be generated based on that trend. If a consistent trend of slow waiter service is recorded in the same geographical subunit of a restaurant, a report for more wait staff to that geographical subunit may be generated.

Hardware System Examples

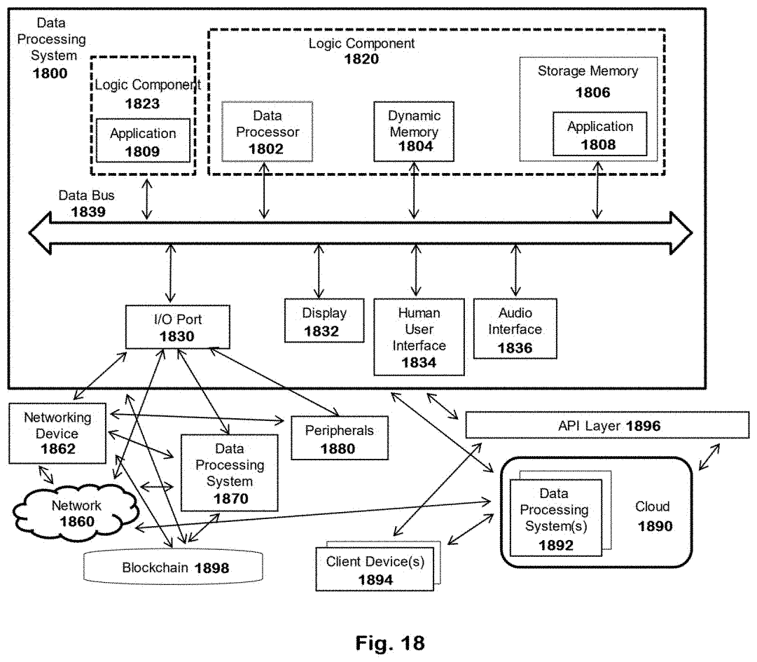

FIG. 18 shows an example data processing system 1800 that may be used in connection with various embodiments and that may be configured to execute instructions for performing functions and methods described and/or claimed in connection with various embodiments. In various implementations, the data processing system 1800 represents any of the data processing systems used by the user of the mobile smart device 1660 in FIG. 16 or the data processing device in the embodiment of FIG. 17.

In various embodiments, the data processing system 1800 is an electronic mobile and wireless device such as but not limited to a tablet comprising a touch display sensitive screen, a mobile phone, a wearable device such as a watch or glasses, a vehicle entertainment system, a vehicle navigation system, a vehicle information system, or another mobile personal communication device. Examples of electronic tablets in accordance with various embodiments include an iPad tablet computer currently commercialized by Apple Inc. and running an iOS operating system, a tablet computer running the Android operating system currently developed by Google Inc, a tablet running the Windows operating system, and any other electronic tablet devices. Examples of mobile phones in accordance with various embodiments include a mobile phone using an iOS operating system (iPhone), a mobile phone using an Android operating system, a mobile phone using a Windows operating system, and other mobile phones. Examples of wearable devices in accordance with various embodiments include a watch with an electronic display, and an electronic eyewear device (e.g., electronic glasses such as Google Glass or other devices with a similar form factor), an in-ear or over-ear wearable device, and others. In various embodiments, an electronic tablet or a mobile phone is adapted to run one or more mobile apps that perform various functions. Examples of a vehicle entertainment system, vehicle navigation system, or vehicle information system in accordance with various embodiments includes any device that can relay visual or auditory information to a driver or passenger in a vehicle or other transportation device (e.g., car, bus, train, plane, ship, subway, elevator, etc.), including for example a car entertainment system that can display or recite to a driver or a passenger information about a shopping menu, product or service. Systems and methods here may be utilized on any future hardware and software implementations as well as those currently in use at the time of filing. The examples described herein are not intended to be limiting.

The exemplary data processing system 1800 includes a data processor 1802. The data processor 1802 represents one or more data processing devices such as a microprocessor or other central processing unit. More particularly, the processing device may be a complex instruction set computing (CISC) microprocessor, a reduced instruction set computing (RISC) microprocessor, a very long instruction word (VLIW) microprocessor, a processor implementing other instruction sets, or a processor implementing a combination of instruction sets, whether in a single core or in a multiple core architecture, and any quantum-based processor. Data processor 1802 may also be or include one or more special-purpose processing devices such as an application specific integrated circuit (ASIC), a field programmable gate array (FPGA), a digital signal processor (DSP), network processor, any other embedded processor, or the like. The data processor 1802 may execute instructions for performing operations and steps in connection with various embodiments of the present invention. In various implementations, data processor 1802 may be based on an ARM architecture commercialized by ARM Limited, x86, x32, x64 or subsequent architectures commercialized by Intel Corporation, x86-64 or subsequent architectures commercialized by Advanced Micro Devices, Inc., and/or on other processor architectures suitable that provide desirable attributes of performance, size, power consumption, packaging, features, cost, and/or other characteristics. In some embodiments (e.g. for mobile device applications), data processor 1802 may be, may be included in, or may include a system on a chip (SoC) design comprising one or more CPU cores, one or more graphics processing unit (GPU), one or more wireline or wireless modems, one or more global positioning system (GPS) components, camera functionality, gesture recognition functionality, video functionality, and/or other software and hardware features.

In an exemplary embodiment, the data processing system 1800 may further include a dynamic memory 1804, which may be designed to provide higher data read speeds. Examples of dynamic memory 1804 include dynamic random access memory (DRAM), synchronous DRAM (SDRAM) memory, read-only memory (ROM) and flash memory. The dynamic memory 1804 may be adapted to store all or part of the instructions of a software application, as these instructions are being executed or may be scheduled for execution by data processor 1802. In some implementations, the dynamic memory 1804 may include one or more cache memory systems that are designed to facilitate lower latency data access by the data processor 1802.

In this exemplary embodiment, the data processing system 1800 further includes a storage memory 1806, which may be designed to store larger amounts of data. Examples of storage memory 1806 include a magnetic hard disk and a flash memory component. In various implementations, the data processing system 1800 may also include, or may otherwise be configured to access one or more external storage memories, such as an external memory database or other memory data bank, which may either be accessible via a local connection (e.g., a wired or wireless USB, Bluetooth, or WiFi interface), or via a network (e.g., a remote cloud-based memory volume).

A storage memory may also be denoted a memory medium, storage medium, dynamic memory, or memory. In general, a storage memory, such as the dynamic memory 1804 and the storage memory 1806, may include any chip, device, combination of chips and/or devices, or other structure capable of storing electronic information, whether temporarily, permanently or quasi-permanently. A memory medium could be based on any magnetic, optical, electrical, mechanical, electromechanical, MEMS, quantum, or chemical technology, or any other technology or combination of the foregoing that is capable of storing electronic information. A memory medium could be centralized, distributed, local, remote, portable, or any combination of the foregoing. Examples of memory media include a magnetic hard disk, a random access memory (RAM) component, an optical disk (e.g., DVD, CD), and a flash memory card, stick, disk or component.

A software application or component, and any other computer executable instructions, may be stored on any such storage memory, whether permanently or temporarily, including on any type of disk (e.g., a floppy disk, optical disk, CD-ROM, and other magnetic-optical disks), read-only memory (ROM), random access memory (RAM), EPROM, EPROM, magnetic or optical card, or any other type of media suitable for storing electronic instructions.

In general, a storage memory could host a database, or a part of a database. Conversely, in general, a database could be stored completely on a particular storage memory, could be distributed across a plurality of storage memories, or could be stored on one particular storage memory and backed up or otherwise replicated over a set of other storage memories. Examples of databases include operational databases, analytical databases, data warehouses, distributed databases, end-user databases, external databases, hypermedia databases, navigational databases, in-memory databases, document-oriented databases, real-time databases and relational databases.

Storage memory 1806 may include one or more software applications 1808, in whole or in part, stored thereon. In general, a software application, also denoted a data processing application or an application, may include any software application, software component, function, procedure, method, class, process, or any other set of software instructions, whether implemented in programming code, firmware, or any combination of the foregoing. A software application may be in source code, assembly code, object code, or any other format. In various implementations, an application may run on more than one data processing system (e.g., using a distributed data processing model or operating in a computing cloud), or may run on a particular data processing system or logic component and may output data through one or more other data processing systems or logic components.

The exemplary data processing system 1800 may include one or more logic components 1820 and/or 1821, also denoted data processing components, or components. Each logic component 1820 and/or 1821 may consist of (a) any software application, (b) any portion of any software application, where such portion can process data, (c) any data processing system, (d) any component or portion of any data processing system, where such component or portion can process data, and (e) any combination of the foregoing. In general, a logic component may be configured to perform instructions and to carry out the functionality of one or more embodiments of the present invention, whether alone or in combination with other data processing components or with other devices or applications. Logic components 1820 and 1821 are shown with dotted lines in FIG. 18 to further emphasize that data processing system 1800 may include one or more logic components, but does not have to necessarily include more than one logic component.

As an example of a logic component comprising software, logic component 1821 shown in FIG. 18 consists of application 1809, which may consist of one or more software programs and/or software components. Logic component 1821 may perform one or more functions if loaded on a data processing system or on a logic component that comprises a data processor.

As an example of a logic component comprising hardware, the data processor 1802, dynamic memory 1804 and storage memory 1806 may be included in a logic component, shown in FIG. 18 as exemplary logic component 1820. Examples of data processing systems that may incorporate both logic components comprising software and logic components comprising hardware include a desktop computer, a mobile computer, or a server computer, each being capable of running software to perform one or more functions defined in the respective software.

In general, functionality of logic components may be consolidated in fewer logic components (e.g., in a single logic component), or may be distributed among a larger set of logic components. For example, separate logic components performing a specific set of functions may be equivalent with fewer or a single logic component performing the same set of functions. Conversely, a single logic component performing a set of functions may be equivalent with a plurality of logic components that together perform the same set of functions. In the data processing system 1800 shown in FIG. 18, logic component 1820 and logic component 1823 may be independent components and may perform specific functions independent of each other. In an alternative embodiment, logic component 1820 and logic component 1821 may be combined in whole or in part in a single component that perform their combined functionality. In an alternative embodiment, the functionality of logic component 1820 and logic component 1821 may be distributed among any number of logic components. One way to distribute functionality of one or more original logic components among different substitute logic components is to reconfigure the software and/or hardware components of the original logic components. Another way to distribute functionality of one or more original logic components among different substitute logic components is to reconfigure software executing on the original logic components so that it executes in a different configuration on the substitute logic components while still achieving substantially the same functionality. Examples of logic components that incorporate the functionality of multiple logic components and therefore can be construed themselves as logic components include system-on-a-chip (SoC) devices and a package on package (PoP) devices, where the integration of logic components may be achieved in a planar direction (e.g., a processor and a storage memory disposed in the same general layer of a packaged device) and/or in a vertical direction (e.g. using two or more stacked layers).

The exemplary data processing system 1800 may further include one or more input/output (I/O) ports, illustrated in FIG. 18 as I/O port 1810, for communicating with other data processing system (e.g., data processing system 1870), with other peripherals (e.g., peripherals 1880), or with one or more networks (e.g., network 1860). Each I/O port 1810 may be configured to operate using one or more wired and/or wireless communication protocols, such as, for example, any protocols available in network 1860, any protocols available to connect directly or indirectly to another data processing system such as data processing system 1870, and/or any protocols available to connect directly or indirectly to peripherals such as Peripherals 1880. In general, each I/O port 1810 may be able to communicate through one or more communication channels and/or to connect to one or more networks, such as network 1860 as illustrated in FIG. 18. The data processing system 1800 may communicate directly with other data processing systems, such as data processing system 1870 (e.g., via a direct wireless or wired connection), or via the one or more networks 1860.

A communication channel or data network may include any direct or indirect data connection path, including any connection using a wireless technology (e.g., Bluetooth, infrared, WiFi, WiMAX, cellular, 3G, 4G, 5G, EDGE, CDMA and DECT), any connection using wired (also sometimes denoted “wireline”) technology (including via any serial, parallel, wired packet-based communication protocol (e.g., Ethernet, USB, FireWire, etc.), or other wireline connection), any optical channel (e.g., via a fiber optic connection or via a line-of-sight laser or LED connection), and any other point-to-point connection capable of transmitting data.

Each of the networks 1860 may include one or more communication channels. In general, a network, or data network, consists of one or more communication channels that can be established between devices connected to each other directly or indirectly through that network. Examples of networks include a LAN, MAN, WAN, cellular and mobile telephony network, the Internet, the World Wide Web, and any other information transmission network. In various implementations, the data processing system 1800 may include additional interfaces and communication ports in addition to the I/O Port 1810.

In various embodiments, a network, such as network 1860, may include a collection of terminal nodes, links and any intermediate nodes. A network maybe wired or wireless. An example of a wired network is an Ethernet network. An example of a wireless network is a WiFi network.

An example of a short-distance communication channel or network are near-field communication (NFC) applications, which are employed in some mobile devices to automate device-to-device transactions, such as payments, data synchronization, and other information exchange. Another example of a short-distance communication channel or network are radio frequency identification (RFID) data transfers that can be used to identify individual items using low-power communications (e.g., merchandize identification, automatic inventory, etc.). Another example of a short-distance communication channel or network is Bluetooth.

In one embodiment, the data processing system 1800 comprises a wireless communication component that enables the data processing system 1800 to communicate wirelessly via network 1860, using a wireless data protocol made available in the network 1860 (e.g., a WiFi protocol). The network 1860 may include both wireless and wireline connections (e.g., may permit communications using both WiFi and Ethernet protocols). In one embodiment, the network 1860 may consist of two or more networks, whether wireless or wired, and the two or more networks may operate independently (e.g., to increase security by separating communications) or may be connected to each other (e.g., to facilitate communications among devices connected to different networks).

In one embodiment, the data processing system 1800 is located in a particular facility (e.g., in an establishment), and the network 1860 represents a combination of an internal network deployed within that facility and an external communication channel or network that provides a connection to the Internet. In one embodiment, the data processing system 1800 could be connected directly to the Internet through the network 1860, could be connected to the Internet through an intermediate data processing system that acts as a gateway, or could be connected to the Internet through one or more networking devices, such as networking device 1862 illustrated in FIG. 18 (e.g., a router, a modem, a gateway). In one embodiment, the data processing system 1800 could be connected directly or indirectly to the Internet through the network 1860 and could act as a gateway for one or more other data processing systems (e.g., other computing devices, peripheral devices used in transactions, etc.).

In one embodiment, the data processing system 1800 may communicate with a cloud or other remote data processing system via the network 1860. In various embodiments, the cloud or other remote data processing system may assist the data processing system 1800 to conduct or facilitate a transaction (e.g., authenticating a user or a payment method, conducting or mediating a payment transaction, collecting or returning data or analytical information about a user, etc.).

In various embodiments, the network 1860 is, or includes a network that facilitates communications at longer distances. In various embodiments, the network 1860 is, or includes, a 3G network, a 4G network, a 5G network, an EDGE network, a CDMA network, a GSM network, a 3GSM network, a GPRS network, an EV-DO network, a TDMA network, an iDEN network, a DECT network, a UMTS network, a WiMAX network, a cellular network, any type of wireless network that uses a TCP/IP protocol or other type of data packet or routing protocol, any other type of wireless wide area network (WAN) or wireless metropolitan area network (MAN), or a satellite communication channel or network. Each of the foregoing types of networks that could be used within the network 1860 utilizes various communication protocols, including protocols for establishing connections, transmitting and receiving data, handling various types of data communications (e.g., voice, data files, HTTP data, images, binary data, encrypted data, etc.), and otherwise managing data communications. In various embodiments, the data processing system 1800 is configured to be compatible with one or more protocols used in the network 1860, such that the data processing system 1800 can successfully connect to the network 1860 and communicate via the network 1860.

The exemplary data processing system 1800 may further include a display 1812, which provides the ability for a user to visualize data output by the data processing system 1800 and/or to interact with the data processing system 1800. The display 1812 may directly or indirectly provide a graphical user interface (GUI) adapted to facilitate presentation of data to a user and/or to accept input from a user. The display 1812 may consist of a set of visual displays (e.g., an integrated LCD, LED or CRT display), a set of external visual displays, (e.g., an LCD display, an optical projection device, a holographic display), or of a combination of the foregoing.

A visual display may also be denoted a graphic display, computer display, display, computer screen, screen, computer panel, or panel. Examples of displays include a computer monitor, an integrated computer display, electronic paper, a flexible display, a touch panel, a transparent display, and a three dimensional (3D) display or projector that may or may not require a user to wear assistive 3D glasses.

A data processing system may incorporate a graphic display. Examples of such data processing systems include a laptop, a computer pad or notepad, an electronic tablet or other tablet computer, a smart phone or any other mobile phone, an electronic reader (also denoted an e-reader or ereader), a personal data assistant (PDA), a medical device, or any other device that incorporates data processing features and a display for displaying information and/or receiving information from a user.

A data processing system may be connected to an external graphic display. Examples of such data processing systems include a desktop computer, a server, an embedded data processing system, a mobile phone, an electronic tablet, or any other data processing system adapted to display information through an external display, whether or not it includes a display itself. A data processing system that incorporates a graphic display may also be connected to an external display. A data processing system may directly display data on an external display, or may transmit data to other data processing systems or logic components that will eventually display data on an external display.

Graphic displays may include active display, passive displays, LCD displays, LED displays, OLED displays, plasma displays, and any other type of visual display that is capable of displaying electronic information to a user. Such graphic displays may permit direct interaction with a user, either through direct touch by the user (e.g. a touch-screen display that can sense a user's finger touching a particular area of the display), through proximity interaction with a user (e.g., sensing a user's finger being in proximity to a particular area of the display), or through a stylus or other input device. In one implementation, the display 1812 is a touch-screen display that displays a human GUI interface to a user, with the user being able to control the data processing system 1800 through the human GUI interface, or to otherwise interact with, or input data into the data processing system 1800 through the human GUI interface. Examples of touch-screen display technologies include resistive, surface acoustic wave, capacitive, infrared, optical imaging, dispersive signal, and acoustic pulse recognition

The exemplary data processing system 1800 may further include one or more human input interfaces 1814, which facilitate data entry by a user or other interaction by a user with the data processing system 1800. Examples of human input devices 1814 include a keyboard, a mouse (whether wired or wireless), a stylus, other wired or wireless pointer devices (e.g., a remote control), a voice or speech recognition device, or any other user device capable of interfacing with the data processing system 1800. In some implementations, human input devices 1814 may include one or more sensors that provide the ability for a user to interface with the data processing system 1800 via voice, or provide user intention recognition technology (including optical, facial, or gesture recognition), or gesture recognition (e.g., recognizing a set of gestures based on movement via motion sensors such as gyroscopes, accelerometers, magnetic sensors, optical sensors, etc.).

The exemplary data processing system 1800 may further include one or more gyroscopes, accelerometers, magnetic sensors, optical sensors, or other sensors that are capable of detecting physical movement of the data processing system. Such movement may include larger amplitude movements (e.g., a device being lifted by a user off a table and carried away or elevation changes experienced by the data processing system), smaller amplitude movements (e.g., a device being brought closer to the face of a user or otherwise being moved in front of a user while the user is viewing content on the display, movement experienced by a vehicle within which the data processing system is located), or higher frequency movements (e.g., hand tremor of a human, vibrations caused by an engine). In the absence of internal motion sensors, or in addition to any internal motion sensors, the exemplary data processing system 1800 may further be capable of receiving and processing information from external motion sensors such as gyroscopes, accelerometers, magnetic sensors, optical sensors, or other sensors that are capable of detecting physical movement of the data processing system.

The exemplary data processing system 1800 may further include an audio interface 1816, which provides the ability for the data processing system 1800 to output sound (e.g., a speaker), to input sound (e.g., a microphone), or any combination of the foregoing.

The exemplary data processing system 1800 may further include any other components that may be advantageously used in connection with receiving, processing and/or transmitting information.

In the exemplary data processing system 1800, the data processor 1802, dynamic memory 1804, storage memory 1806, I/O port 1810, display 1812, human input interface 1814, audio interface 1816, and logic component 1821 communicate to each other via the data bus 1819. In some implementations, there may be one or more data buses in addition to the data bus 1819 that connect some or all of the components of data processing system 1800, including possibly dedicated data buses that connect only a subset of such components. Each such data bus may implement open industry protocols (e.g., a PCI or PCI-Express data bus), or may implement proprietary protocols.

In one embodiment, a data processing system (such as data processing system 1800) is connected to a networking device, illustrated in FIG. 18 as networking device 1862. In various embodiments, the networking device 1862 could act as a router (wireless and/or wired), hub, switch, modem, bridge, repeater, gateway, communication protocol converter, communication buffering device, or virtually any other type of equipment that can perform a networking or communication function. In various embodiments, the networking device 1862 could perform various functions for data processing system 1800, including acting as a connecting hub to other data processing systems (e.g., data processing system 1870) and/or peripherals (e.g., one or more peripherals 1880), providing a layer of security (e.g., acting as a firewall, providing a connection or user authentication layer, etc.), extending the range of a wireless communication channel or network (e.g., in a restaurant or other establishment where data processing systems and peripherals are far from each other or are separated by metallic objects or thick walls), establishing a short-distance network (e.g., a BlueTooth network or other network intended to operate using low power or to provide physical security by limiting the effective connection range), and so on. In various embodiments, the networking device 1862 may be adapted to communicate using a wired connection, such as a serial connection, a wired packet-based communication protocol (e.g., Ethernet, USB, FireWire, etc.), a parallel connection, and/or any other wireline protocol. In various embodiments, the networking device 1862 may be adapted to communicate using a wireless connection, such as a WiFi connection or cellular network connection.

In one embodiment, the networking device 1862 is adapted to handle data communications via a local network (e.g., network 1860 in FIG. 18 could represent a local network, such as a WiFi network) with one or more local data processing systems and/or peripheral devices, such as the data processing system 1870 and the peripheral devices 1880. In one embodiment, the networking device 1862 establishes a local network, and one or more of the data processing system 1800, data processing system 1870, and/or peripheral devices 1880 join this local network. In another embodiment, a local network (e.g., network 1860) is established by another device (e.g., by another wireless and/or wired router, by a data processing system, by a peripheral device, etc.), and the networking device 1862, and one or more of the data processing system 1800, data processing system 1870, and/or peripheral devices 1880 join this local network.

In various embodiments, a local network is a wireless network that facilitates wireless communications between devices that are deployed in a local configuration, for example being collocated within a room, building, facility or location. For example, a local network (e.g., network 1860 in FIG. 18 could represent a local network) may be created within a restaurant, store, other retail location, hotel, gas station, school, employment location, or other business facility or establishment, where a transaction could take place using one or more of the data processing system 1800, data processing system 1870, and/or peripheral devices 1880.

In various embodiments, network 1860 in FIG. 18 could represent a set of local networks, which could be, or could include, wireless and/or wired communication. In one embodiment, a local network could be a WiFi network, including any wireless network compliant with an I6E 802.11 standard, any wireless network for local wireless communications developed by or with the assistance of the WiFi Alliance or other standard bodies or industry groups, or any other wireless local area network. In general, for various embodiments, it is desirable for a local network to be capable of establishing reliable wireless connections between two or more data processing devices and/or peripherals, even if they are not in immediate proximity.

In various embodiments, one or more data processing systems, such as the data processing system 1800 of FIG. 18, may be connected directly or indirectly to a computational cloud, such as cloud 1890 illustrated in FIG. 18. A computational cloud, also denoted a “cloud,” is a set of computing servers that provide computational capability, data storage and/or services capability to one or more client devices. The client devices are typically remote from the cloud and are accessing the cloud via one or more data networks. A cloud could include sophisticated computing and data storage capabilities, including advanced security, performance management, high reliability, redundancy, interoperability with various types of client devices (e.g., various types of data processing systems using different hardware and software configurations could connect to the same cloud and receive similar services), quick and cost-effective computing power provisioning, and so on. For example, in various embodiments, one or more of the data processing system 1800 and the data processing system 1870 may be different types of electronic tablets, mobile phones, laptops or personal computers, and they could both be connected to the cloud 1890 via one or more networks (e.g., network 1860 and/or other data networks). In one embodiment, one or more of the peripheral devices 1880 may also be connected to the cloud 1890.

A cloud, such as cloud 1890, may provide access to various types of services. Services and functionality made available by clouds include Software as a Service (S16S), Platform as a Service (P16S), cloud computing, Infrastructure as a Service (I16S), cloud storage, Internet-based computing, and so on. Depending on their characteristics, clouds may be classified as private clouds, public clouds, hybrid clouds, and so on.

In various embodiments, one or more Application Processing Interfaces (APIs), such as the API layer 1896 illustrated in FIG. 18, may be deployed to facilitate communications between data processing systems, clouds, networks, and/or other systems or components. In general, an API may be or may include a set of subroutine definitions, protocols, and/or tools for building or interconnecting web-based systems, operating systems, database systems, hardware and/or software. API specifications may include specifications for object classes, routines, variables, data structures, and/or remote calls. An advantage of using APIs to interconnect web-based systems, operating systems, database systems, hardware and/or software may include the ability to provide a common communication framework capable of communicating with different types of hardware software or technologies (e.g., data processing systems with Android, iOS, Windows and other Operating Systems may communicate with each other, web systems running on different software environments may exchange data using common protocols, etc.). Another advantage of using APIs to interconnect web-based systems, operating systems, database systems, hardware and/or software may include introducing additional layers of security for the components connected to the API (e.g., by alleviating the need to log in directly into a remote system, by limiting the features or types of data that can be exchanged, by limiting the ability to push v. pull data from a web system or server, etc.). Another advantage of using APIs to interconnect web-based systems, operating systems, database systems, hardware and/or software may include improved scalability of communications (e.g., as the volume of calls through an API increases, additional computing resources can be provisioned on demand to process such calls, etc.).

As shown in the embodiment of FIG. 18, the API layer 1896 can be used to interface a variety of different components and systems, such as the data processing system 1800, the data processing system 1870, the peripherals 1880, one or more client device 1894, and/or the cloud 1890. In general, a wide range of data processing systems or components with communication capabilities could be connected to an API layer using an appropriate protocol and/or data conversion.

Web APIs are a particular class of APIs that provide functionality for interfacing data processing systems, clouds and other servers capable of communicating via the Web or Internet. A Web API may provide an interface through which interactions happen between an enterprise and applications that use its assets. When deployed as a Web API, an API such as the API layer 1896 may provide a programmable interface between a set of services and a set of applications serving different types of users. When used in the context of web development, an API such as the API layer 1896 may be defined as a set of Hypertext Transfer Protocol (HTTP) request messages, along with a definition of the structure of response messages, possibly in an Extensible Markup Language (XML) or JavaScript Object Notation (JSON) format. In a Web context, APIs such as the API layer 1896 may support Simple Object Access Protocol (SOAP) based web services, service-oriented architectures (SOA), direct representational state transfer (REST) style web resources, and/or resource-oriented architecture (ROA). In various implementations, the API layer 1896 is, or is included in the API layer 190 from the embodiment of FIG. 16.

In various implementations, terms such as cloud service, cloud-based service, cloud functionality, cloud-based functionality, cloud application and/or cloud-based application are used to denote software running in a computing cloud and performing various functions. Examples of such cloud-based features may include email systems, portals for accessing information stored in the cloud, applications collecting and/or analyzing data in the cloud, applications residing in the cloud and interfacing with mobile devices (e.g., mobile phones) or other user terminals, and other similar applications, features and/or services. A particularly useful class of cloud-based services are S16S platforms providing a wide range of functionality such as management, data analytics and reporting, marketing management and automation, financial management and reporting, billing and payments, and other features amenable to cloud-based deployment. A S16S platform may also include any 5G implementation where the processing or data may be distributed throughout the communications infrastructure.

As an example, data processing system 1800 may be connected to cloud 1890 through one or more communication channels or networks and may store data in the cloud for backup purposes and/or to enable various cloud-based services based on that data. Correspondingly, data processing system 1800 may receive data from cloud 1890 on demand and/or at predefined intervals. Cloud 1890 may include one or more portals for administering, monitoring, configuring, and/or controlling the data processing system 1800. The portal in the cloud 1890 may permit one or more users to log in and access data received from the data processing system 1800 and/or otherwise available in the cloud, including records of data and data analytics. In one embodiment, a cloud may perform an authentication function for a data processing system connected to the cloud, and may be configured to remotely shut down, erase, reset, update an operating system or application, or otherwise configure or restrict the operation of a remote data processing system under various circumstances (e.g., unauthorized access of the data processing system or of a cloud portal).

In various embodiments, the data processing system 1800 and other systems or components shown in the embodiment of FIG. 18 (e.g., the networking device 1862, the data processing system 1870, the network 1860, one or more of the client devices 1894, the API layer 1896, etc.) may be connected to a blockchain or combination of blockchains, illustrated as blockchain 1898 in FIG. 18. Blockchains were discussed in more detail in connection with the embodiment of FIG. 16. In various embodiments, the blockchain 1898 may represent the blockchain 196 discussed in connection with the embodiment of FIG. 16. In various embodiments, the blockchain 1898 may facilitate transactions and/or smart contracts involving cryptocurrencies and/or cryptographic tokens, as generally described in connection with the embodiment of FIG. 16.

This specification describes in detail various embodiments and implementations of the present invention, and the present invention is open to additional embodiments and implementations, further modifications, and alternative and/or complementary constructions. There is no intention in this patent to limit the invention to the particular embodiments and implementations disclosed; on the contrary, this patent is intended to cover all modifications, equivalents and alternative embodiments and implementations that fall within the scope of the claims. As used in this specification, a set means any group of one, two or more items. Analogously, a subset means, with respect to a set of N items, any group of such items consisting of N-1 or less of the respective N items.

In summary, benefits of the system include but are not limited to: many requesters to many service providers within a single login; personalized requester main communications screen; requester does not need service provider contact information; requester does not need an account with service provider; requester does not need service provider application or login credentials; requester can use stored payment information to reduce security risks; requester does not need to provide location to service provider; requester can see status of requests in real time; service provider does not need personnel to manually capture orders; service provider can have requests delivered directly to the service delivery personnel; service provider can receive optimized routing information for most efficient delivery; service provider can receive detailed information about their operational performance; service provider can have bi directional communication with requester in real time.

### CONCLUSION

In general, unless otherwise stated or required by the context, when used in this patent in connection with a method or process, data processing system, or logic component, the words “adapted” and “configured” are intended to describe that the respective method, data processing system or logic component is capable of performing the respective functions by being appropriately adapted or configured (e.g., via programming, via the addition of relevant components or interfaces, etc.), but are not intended to suggest that the respective method, data processing system or logic component is not capable of performing other functions. For example, unless otherwise expressly stated, a logic component that is described as being adapted to process a specific class of information will not be construed to be exclusively adapted to process only that specific class of information, but may in fact be able to process other classes of information and to perform additional functions (e.g., receiving, transmitting, converting, or otherwise processing or manipulating information).

As used in this specification, the terms “include,” “including,” “for example,” “exemplary,” “e.g.,” and variations thereof, are not intended to be terms of limitation, but rather are intended to be followed by the words “without limitation” or by words with a similar meaning. Definitions in this specification, and all headers, titles and subtitles, are intended to be descriptive and illustrative with the goal of facilitating comprehension, but are not intended to be limiting with respect to the scope of the inventions as recited in the claims. Each such definition is intended to also capture additional equivalent items, technologies or terms that would be known or would become known to a person of average skill in this art as equivalent or otherwise interchangeable with the respective item, technology or term so defined. Unless otherwise required by the context, the verb “may” or “could” indicates a possibility that the respective action, step or implementation may or could be achieved, but is not intended to establish a requirement that such action, step or implementation must occur, or that the respective action, step or implementation must be achieved in the exact manner described.

Some of the embodiments described in this application (or, upon issuance, patent) may be presented in terms of algorithms and symbolic representations of operations on data bits within a computer memory. In general, an algorithm represents a sequence of steps leading to a desired result. Such steps generally require physical manipulations of physical quantities. Usually, though not necessarily, these quantities take the form of electrical or magnetic signals capable of being stored, transferred, combined, compared, and otherwise manipulated using appropriate electronic devices. Such signals may be denoted as bits, values, elements, symbols, characters, terms, numbers, or using other similar terminology.

When used in connection with the manipulation of electronic data, terms such as processing, computing, calculating, determining, displaying, or the like, refer to the action and processes of a computer system or other electronic system that manipulates and transforms data represented as physical (electronic) quantities within the system's registers and memories into other data similarly represented as physical quantities within the memories or registers of that system of or other information storage, transmission or display devices.

Various embodiments of the present invention may be implemented using an apparatus or machine that executes programming instructions. Such an apparatus or machine may be specially constructed for the required purposes, or may comprise a general purpose computer selectively activated or reconfigured by a software application.

Algorithms discussed in connection with various embodiments are not inherently related to any particular computer or other apparatus. Various general purpose systems may be used with programs in various embodiments, or in some embodiments more specialized systems, devices or components could be deployed to perform the respective functions. Embodiments are not described with reference to any particular programming language, data transmission protocol, or data storage protocol. Instead, a variety of programming languages, transmission or storage protocols may be used to implement various embodiments.

What is claimed is:

1. A method comprising:
by a server computer in communication with a network, configured to send and receive messages within a geographical location,
receiving a request from a front end device;
assigning a geo-code to the requesting front end device;
wherein, the geo-code includes a geographical subunit configured to identify a geographical location of the front end device and a message subunit configured with predetermined messages that correlate to the geographical location of the front end device;
by the server computer, receiving a log-in identifier from the front end device through the log-in portal;
by the server computer, authenticating the front end device;
by the server computer, receiving a selected message of the message subunits from the authenticated front end device, the selected message allows communicating with a service response system correlated to the message subunit;
and
routing the received selected message to the service response system correlated with the message subunit.

2. The method of claim 1 wherein routing the received selected messages to the service response system is by an address associated with the selected message of the message subunit.

3. The method of claim 2 further comprising, allowing the users of the service response system to respond to the received selected message with a pre-selected response, or a free text entry.

4. The method of claim 2 further comprising, display of a count-up message timer on the main communications page when one of the communication shortcuts is selected by a user of the front end device, and display of a synchronized count-up message timer on the service response system subunit for the same message.

5. The method of claim 4 further comprising, allowing the users of the service response system to stop and remove the user interface icon of a count-up message timer.

6. The method of claim 5 further comprising, receiving selection of the timer from the front end device, storing, by the server, timing data regarding the received selection of the timer;
sending, by the server to the front end device, a timing response message;
and analyzing the timing data to determine trends.

7. The method of claim 5 further comprising, allowing the users of the service response system to order the messages from the front end device by selecting the corresponding geographical subunits to which the received geo-codes are sent; and
allowing the users of the service response system to order the messages from the front end device by selecting the corresponding timers corresponding to the count-up timer of when the messages were sent.

8. The method of claim 1 wherein the main communications page for the front end user includes a pass through link that links a third party website or external application to the main communications page, and redirecting the device to the third party website or opening of the external application if selected on the main communications page.

9. The method of claim 1 wherein the main communications page is configured to allow messages between the front end device and service response system, using at least one of text, voice recording, video, and image capture.

10. The method of claim 1 wherein the front end device geo code is registered corresponding to the geographic location, wherein assigning the geo code to the front end device is by at least one of, a URL with parameters containing the geo-code information, a quick reference (QR) code which contains this URL, a moving image validation, or a barcode containing the geo-code information, or manual entry by the user of the front end device.

11. The method of claim 1 further comprising, causing storage of every authenticated session for each front end device correlated to the geographic location.

12. The method of claim 1 further comprising, causing storage of data regarding at least one of, every message sent and received by every logged in front end device, timing of every message sent, as well as the corresponding geographic subunit for analysis of trends; and
determining, by the server computer, at least one analytical report using a subset of data from at least one of the stored message, log-in, and timing data,
wherein the data used to determine the analytical report is at least one of, a service metric, performance data of staff, a number of service requests, a time interval between requests, an efficiency metric for a plurality of requests, and a problem with a request.

13. The method of claim 1 further comprising, by the server computer, receiving a selection, by the main communication page, of a free-text message or predetermined message correlated to one of the communications shortcuts, allowing free-text entry or predetermined message entry by the user of the front end device; and
sending the received free-text entry or predetermined message entry to the back end subunit without requiring an input address from the front end device user to send and receive messages to the service response system users.

14. The method of claim 1, wherein authenticating the front end device includes, by the server computer, after receiving the log-in identifier, sending a code by short message system (SMS) to the front end device;
by the server computer, receiving a response code from the front end device, comparing the received response code and the sent code, and if the response code matches the sent SMS code, authenticating,
wherein authenticating the front end device includes causing storage of the received log-in identifier and an indicator that the received log-in identifier is authenticated.

15. A method of communicating, comprising,
receiving, at a service response system device, a message from a front end device, by a back end network, wherein the service response system subunit device and the front end device are in communication with a network,
wherein the message from the front end device having been selected from a previously arranged communication shortcut and filtered to apply to the service response system device configuration from multiple service response system devices, each configured to display messages intended for a subunit;
causing display, at the filtered service response system subunit device, the message received from the front end device, along with a geographical subunit correlated to the physical location of the front end device as determined by the authenticated geo-coded communication channel for the front end device;
allowing a user of the service response system subunit device to order messages received from multiple other front end devices, each with their own geo-code correlated physical location;
allowing the user of the service response system subunit device to send response messages to the front end device in response to a received message.

16. The method of claim 15 further comprising, by the back end network, causing storage of time data for messages sent between front end devices and service response system subunits and message traffic data for messages sent between front end devices and service response system subunits.

17. The method of claim 16 further comprising, by the back end network, causing storage of geographic location of front end devices that send messages to the service response system subunits.

18. The method of claim 17 further comprising,
by the back end network, performing analytics on the timing, message, and geographical location data by determining frequency rates of messages at specific times in specific geographical locations.

19. A method comprising:
by an application running on a front end device,
sending a message from a front end device the message including data regarding a geo-code,
wherein, the sent geo-code correlates to a geographical subunit, the geo-code is part of a URL of a log-in portal;
by the application, sending a login identifier by the log-in portal to a back-end server computer for authentication;
receiving, from the back-end server computer, a main communications page that allows communicating with a service response system, the service response system in communication with the back-end server computer; and
sending a selection, by the main communication page, from previously determined communications shortcuts or free text communications shortcuts, each filtered for the service response system, such that the user of the front end device does not need to enter an address to send and receive messages to service response system users.

20. The method of claim 19, wherein authenticating the front end device includes, by the server computer, after receiving the log-in identifier, sending a code by short message system (SMS) to the front end device;
by the server computer, receiving a response code from the front end device, comparing the received response code and the sent code, and if the response code matches the sent SMS code, authenticating,
wherein authenticating the front end device includes causing storage of the received log-in identifier and an indicator that the received log-in identifier is authenticated.
